(19) United States
(12) Patent Application Publication
(10) Pub. No.: US 2021/0100344 A1
(43) Pub. Date: Apr. 8, 2021

(54) ERGONOMIC POLE AND MODULAR HEAD CLEANING IMPLEMENT

(71) Applicant: Unger Marketing International, LLC, Bridgeport, CT (US)

(72) Inventor: James M. Buckley, New Hartford, CT (US)

(21) Appl. No.: 17/126,936

(22) Filed: Dec. 18, 2020

Related U.S. Application Data
(63) Continuation-in-part of application No. 16/799,242, filed on Feb. 24, 2020.
Application No. 16/799,242 is a continuation-in-part of application No. 16/796,414, filed on Feb. 20, 2020.
(60) Provisional application No. 62/811,803, filed on Feb. 28, 2019.
(60) Provisional application No. 62/811,822, filed on Feb. 28, 2019.

(51) Int. Cl. A46B 5/00; A46B 9/02

(52) U.S. Cl. CPC A46B 5/0012; A46B 2200/302; A46B 5/0095; A46B 9/025

(57) ABSTRACT

Tools for cleaning surfaces are described. The tools include a pole having a first end and a second end with two bent segments. A head member assembly is coupled to the pole. The head member assembly includes a center head member coupled to the pole and having at least one tongue member extending from an end of the center head member. A first plurality of bristles extends from a surface of the center head member opposite the pole. An end module is removably coupled to the tongue member of the center head member and includes a second plurality of bristles positioned adjacent the first plurality of bristles. The second plurality of bristles includes a first portion of bristles that extend at a first angle relative to an end surface of the end module in a direction away from the pole.

### CROSS REFERENCE TO RELATED APPLICATIONS

This application is a Continuation-in-Part Application of U.S. application Ser. No. 16/799,242, filed on Feb. 24, 2020, which claims priority to U.S. Provisional Application Ser. No. 62/811,803, filed Feb. 28, 2019, the entire disclosure of which is incorporated herein by reference. This application is also a Continuation-in-Part Application of U.S. application Ser. No. 16/796,414, filed on Feb. 20, 2020, which claims priority to U.S. Provisional Application Ser. No. 62/811,822, filed Feb. 28, 2019. The contents of these priority applications are incorporated herein in their entireties.

### BACKGROUND

The subject matter disclosed herein relates to a tool for cleaning surfaces such as a floor, and in particular to a cleaning tool such as a broom, mop, brush, or squeegee that has an ergonomic pole and modular element(s) allowing the cleaning tool to be configured during manufacturing or by an end user.

Cleaning tools and implements, such as brooms and brushes, typically include bristles that are used to sweep or gather up debris from the floor. These brooms and brushes are fixed in size and configuration, resulting in dedicated manufacturing lines and increased inventory. Further, it has been found that different types of bristles are suited for cleaning different types of debris. Existing brooms are limited to two different types of bristles. Thus, a user may have to have several different types of brooms depending on the type of environment being cleaned.

Additionally, in operation and use, the poles for cleaning tools can require continuous forward and downward forces, typically having straight poles. Due to a need to apply a downward and forward force simultaneously, the user typically puts a palm of one hand on the end of the pole and their other hand part partially down the pole. In order to keep the cleaning implement at a desired angle for efficient operation (e.g., squeegees will chatter if not held at a desired angle), and because the poles are straight, the user will assume a bent over position while using the cleaning implement. This is obviously less than desired because it could lead to faster fatigue.

Accordingly, while existing cleaning tools and implements are suitable for their intended purposes, the need for improvement remains, particularly in providing a cleaning implements and tools having the features described herein.

### BRIEF DESCRIPTION

According to one aspect of the disclosure, tools for cleaning surfaces are provided. The tools include a pole having a first end and a second end. The pole includes a first bent segment and a second bent segment. A head member assembly is coupled to the first end of the pole. The head member assembly includes a center head member configured to be coupled to the first end of the pole, the center head member having at least one tongue member extending from an end of the center head member, a first plurality of bristles extending from a surface of the center head member opposite the pole, an end module removably coupled to the tongue member of the center head member, and a second plurality of bristles extending from a surface of the end module and positioned adjacent the first plurality of bristles, the second plurality of bristles including a first portion of bristles that extend at a first angle relative to an end surface of the end module in a direction away from the pole.

In addition to one or more of the features described herein, or as an alternative, further embodiments of the tool may include that a portion of the first bent segment is disposed on an angle of about 25 degrees to 40 degrees relative to a surface being cleaned when the head member assembly is in an operating position.

In addition to one or more of the features described herein, or as an alternative, further embodiments of the tool may include that the second end is positioned about 630-1400 mm from the surface when the head member assembly is in the operating position.

In addition to one or more of the features described herein, or as an alternative, further embodiments of the tool may include that the first angle is greater than or equal to 0 and less than or equal to 90 degrees.

In addition to one or more of the features described herein, or as an alternative, further embodiments of the tool may include that the first plurality of bristles includes a plurality of periphery bristles and a plurality of center bristles, the plurality of center bristles being different than periphery bristles.

In addition to one or more of the features described herein, or as an alternative, further embodiments of the tool may include that the second plurality of bristles includes a second portion of bristles, the second portion of bristles being different than the first portion of bristles, the periphery bristles and the plurality of center bristles.

In addition to one or more of the features described herein, or as an alternative, further embodiments of the tool may include that the first plurality of bristles have a different material, diameter, bristle shape, straight or crimped, flagged or unflagged, or stiffness than the second plurality of bristles.

In addition to one or more of the features described herein, or as an alternative, further embodiments of the tool may include that a portion of the first bent segment is disposed on an angle of about 30 to 60 degrees when the floor cleaning implement is in the operating position.

In addition to one or more of the features described herein, or as an alternative, further embodiments of the tool may include that the second bent segment comprises at least one straight segment and a curved segment, wherein at least one of the straight segments of the second bent segment is configured to change length.

In addition to one or more of the features described herein, or as an alternative, further embodiments of the tool may include that the first bent segment comprises a first curved segment and a first straight segment and the second bent segment comprises a second curved segment and a second straight segment.

In addition to one or more of the features described herein, or as an alternative, further embodiments of the tool may include that the pole includes at least one of (i) a first curved portion along the first bent segment and (ii) a second curved portion along the second bent segment.

In addition to one or more of the features described herein, or as an alternative, further embodiments of the tool may include that the first bent segment comprises a first segment having a first axis and a second segment having a second axis, and the second bent segment comprises a third segment having a third axis, wherein a first intersection of the first axis and the second axis define a first datum point and a second intersection of the second axis and the third axis defining a second datum point.

In addition to one or more of the features described herein, or as an alternative, further embodiments of the tool may include that the third segment has a length of about 670-790 mm from the second datum point to the second end.

In addition to one or more of the features described herein, or as an alternative, further embodiments of the tool may include that the first segment has a length of about 150-270 mm from the first end to the first datum point.

In addition to one or more of the features described herein, or as an alternative, further embodiments of the tool may include an additional end module removably coupled to a tongue member of the center head member opposite the end module.

According to some embodiments, tools for cleaning surfaces are provided. The tools include an ergonomic pole having a pole having a first end and a second end, the pole further having a first segment adjacent the first end, a third segment adjacent the second end and a second segment disposed between the first segment and the third segment. The tools also include a cleaning implement coupled to the first end. The first segment is disposed on a functional angle of about 30 degrees to 60 degrees relative to a surface being cleaned when the floor cleaning implement is in an operating position and at least one of the second segment and the third segment is adjustable from a respective first length to a respective second length. The cleaning implement includes a center head member configured to be coupled to the first end of the pole, the center head member having a first tongue member extending from a first end of the center head member and a second tongue member extending from a second end of the center head member opposite the first tongue member, a first end module removably coupled to the first tongue member, and a second end module removably coupled to the second tongue member. Each of the center head member, the first end module, and the second end module include a respective plurality of cleaning element extending therefrom.

In addition to one or more of the features described herein, or as an alternative, further embodiments of the tool may include that the cleaning elements of the center head member, the first end module, and the second end module are bristles.

In addition to one or more of the features described herein, or as an alternative, further embodiments of the tool may include that the bristles of the center head member, the first end module, and the second end module include one or more groups of bristles having different characteristics selected from a group consisting of bristle diameter, bristle shape, flagged/unflagged bristles, straight/crimped bristles, stiffness, and material.

In addition to one or more of the features described herein, or as an alternative, further embodiments of the tool may include that the bristles have a bristle shape selected from a group consisting of round, triangular, quadrilobal, and rectangular.

In addition to one or more of the features described herein, or as an alternative, further embodiments of the tool may include that the bristles have a bristle material selected from a group consisting of polymer, natural fiber, metal, composite, polyester, polypropylene, nylon, thermoplastic elastomer (TPE), polytetrafluoroethylene, boar hair, horse hair, Tampico fiber, Palmetto fiber, brass, steel, and carbon fiber.

In addition to one or more of the features described herein, or as an alternative, further embodiments of the tool may include a third end module configured to be removably coupled to at least one of the first tongue member or the second tongue member, the third extension member having a respective cleaning element extending therefrom.

In addition to one or more of the features described herein, or as an alternative, further embodiments of the tool may include that the third end module has a length that is longer than the first end module and the second end module.

In addition to one or more of the features described herein, or as an alternative, further embodiments of the tool may include that the first segment and the second segment define a first bent segment and the third segment defines a second bent segment.

These and other advantages and features will become more apparent from the following description taken in conjunction with the drawings.

### BRIEF DESCRIPTION OF DRAWINGS

The subject matter, which is regarded as the disclosure, is particularly pointed out and distinctly claimed in the claims at the conclusion of the specification. The foregoing and other features, and advantages of the disclosure are apparent from the following detailed description taken in conjunction with the accompanying drawings in which:

FIG. 1 is a perspective view of a cleaning tool according to an embodiment;

FIG. 2 is a front view of the cleaning tool of FIG. 1;

FIG. 3 is a side view of the cleaning tool of FIG. 1, the opposite side being a mirror image thereof;

FIG. 4 is a top view of the cleaning tool of FIG. 1;

FIG. 5 is a bottom view of the cleaning tool of FIG. 1;

FIG. 6 is a partially unassembled view of the cleaning tool of FIG. 1;

FIG. 7 is an enlarged view of the head portion of the cleaning tool of FIG. 6;

FIG. 8A is a perspective view of a center head member for the cleaning tool of FIG. 1;

FIG. 8B is a front view of the center head member of FIG. 8A;

FIGS. 8C and 8D are bottom views of the center head member of FIG. 8A;

FIG. 8E is an enlarged bottom view of a portion of the center head member of FIG. 8A;

FIGS. 9A and 9B are partial unassembled perspective views of the head member of the cleaning tool of FIG. 6;

FIG. 9C is a partial front view of the head member of FIG. 6;

FIG. 9D is a partial bottom view of the head member of FIG. 6;

FIG. 9E is a front view of the head member assembly of FIG. 6;

FIG. 9F is a side view of the head member assembly of FIG. 6;

FIG. 9G is a partial front view of a head member assembly in accordance with another embodiment;

FIG. 9H is a partial sectional view of the head assembly of FIG. 9E;

FIG. 10 is a perspective view of a cleaning tool in accordance with another embodiment;

FIG. 11 is a front view of the cleaning tool of FIG. 10;

FIG. 12 is a side view of the cleaning tool of FIG. 10, the opposite side being a mirror image thereof;

FIG. 13 is a top view of the cleaning tool of FIG. 10;

FIG. 14 is a bottom view of the cleaning tool of FIG. 10;

FIG. 15 is a partially unassembled view of the cleaning tool of FIG. 10;

FIG. 16 is an enlarged view of the head portion of the cleaning tool of FIG. 10;

FIG. 17 is a first partial unassembled perspective view of the head portion of FIG. 16;

FIG. 18 is a second partial unassembled perspective view of the head portion of FIG. 16;

FIG. 19 is a partial unassembled front view of the head portion of FIG. 16;

FIG. 20 is a partial unassembled bottom view of the head portion of FIG. 16;

FIG. 21A is an illustration of a bristle bundle with straight bristles;

FIG. 21B is an illustration of a bristle bundle with crimped bristles;

FIG. 22 is a perspective view of a pole for an implement in accordance with an embodiment;

FIG. 23 is a side view of the pole of FIG. 22, the opposite side being a mirror image thereof;

FIG. 24 is a front view of the pole of FIG. 22;

FIG. 25 is a rear view of the pole of FIG. 22;

FIG. 26 is a top view of the pole of FIG. 22;

FIG. 27 is a bottom view of the pole of FIG. 22;

FIG. 28A, 28B and FIG. 28C are various unassembled perspective views of the pole of FIG. 22;

FIG. 29 is a schematic side view of the pole of FIG. 22;

FIG. 30 is a perspective view of a pole for an implement in accordance with another embodiment;

FIG. 31 is a side view of the pole of FIG. 30, the opposite side being a mirror image thereof;

FIG. 32 is a front view of the pole of FIG. 30;

FIG. 33 is a rear view of the pole of FIG. 30;

FIG. 34 is a top view of the pole of FIG. 30;

FIG. 35 is a bottom view of the pole of FIG. 30;

FIG. 36 is a schematic side view of the pole of FIG. 30;

FIG. 37 is a perspective view of a pole for an implement in accordance with another embodiment;

FIG. 38 is a side view of the pole of FIG. 37, the opposite side being a mirror image thereof;

FIG. 39 is a front view of the pole of FIG. 37;

FIG. 40 is a rear view of the pole of FIG. 37;

FIG. 41 is a top view of the pole of FIG. 37;

FIG. 42 is a bottom view of the pole of FIG. 37;

FIG. 43 is a schematic side view of the pole of FIG. 37;

FIG. 44 is a schematic side view of a pole for an implement in accordance with another embodiment;

FIG. 45 is a schematic side view of a pole for an implement in accordance with another embodiment;

FIG. 46A and FIG. 46B are a perspective view and a side view of a pole having a curved upper segment in accordance with another embodiment;

FIG. 47A and FIG. 47B are a perspective view and a side view of a pole having a curved upper segment in accordance with another embodiment;

FIG. 48A and FIG. 48B are a perspective view and a side view of a pole having a curved upper segment in accordance with another embodiment;

FIG. 49 is a schematic illustration of a cleaning tool in accordance with an embodiment of the present disclosure; and

FIG. 50 is a partially unassembled view of the cleaning tool of FIG. 49;

The detailed description explains embodiments of the disclosure, together with advantages and features, by way of example with reference to the drawings.

### DETAILED DESCRIPTION

Embodiments of the present disclosure provide for a cleaning tool (e.g., a broom or mop) for cleaning a floor where the head of the cleaning tool includes a modular head member. The modular head member provides a number of advantages in allowing the head member of the cleaning tool to be configured for different cleaning environments by having cleaning elements or bristles with different properties to be combined. The modular head member further provides manufacturing improvements allowing the fabrication of cleaning tools for different cleaning environments in a cost effective and efficient manner. Still further embodiments include a cleaning tool that provides the user with an interchangeable end modules for different cleaning environments. Still further embodiments include bristles that extend beyond an end of the cleaning tool head to facility cleaning along walls or other vertical surfaces. Still further embodiments include a plurality of bristle types, such as three or more bristle types that facilitate different cleaning environments.

Furthermore, embodiments of the present disclosure provide for an ergonomic pole that is used with implements, such as cleaning implements, squeegees, brooms, brushes, mops, plows, or poles, which allows the user to provide forces in desired direction(s)/vectors without substantially bending their back during normal operation. Embodiments of the present disclosure further provide for an ergonomic pole for use with implements that has an adjustable length to accommodate a user's height.

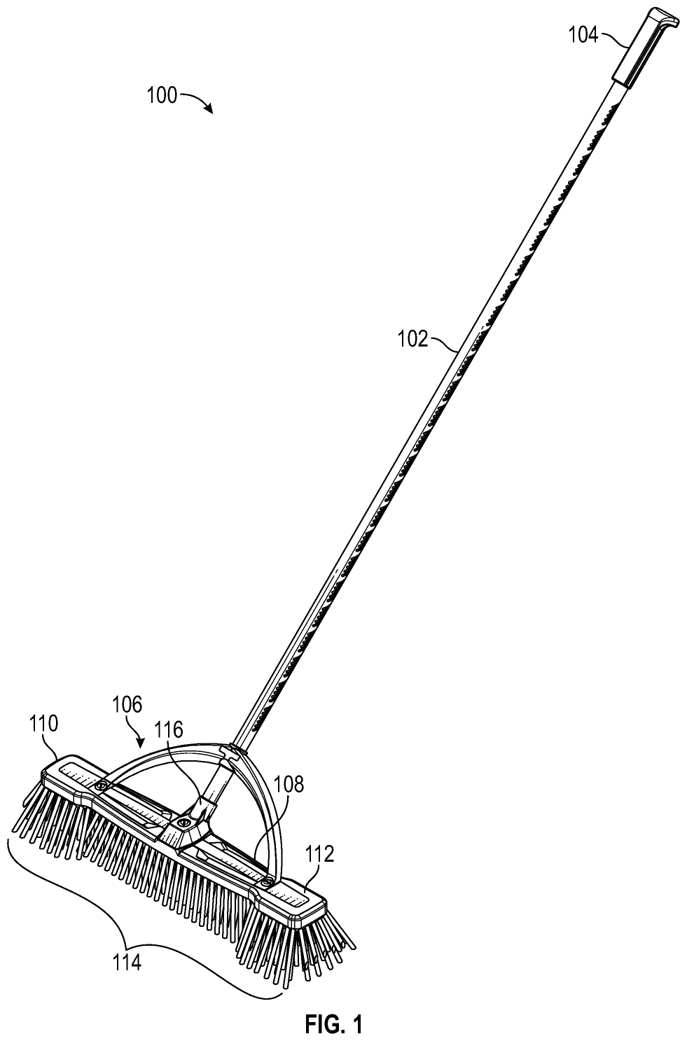

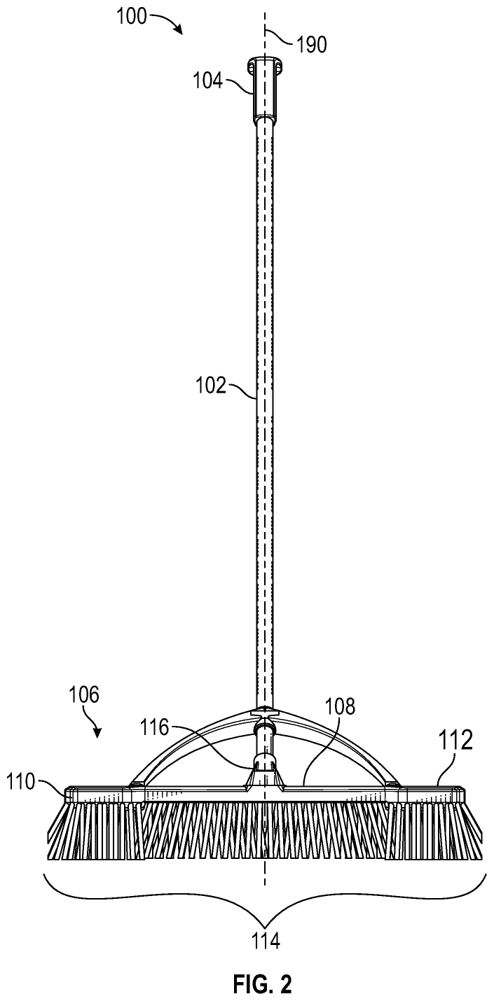

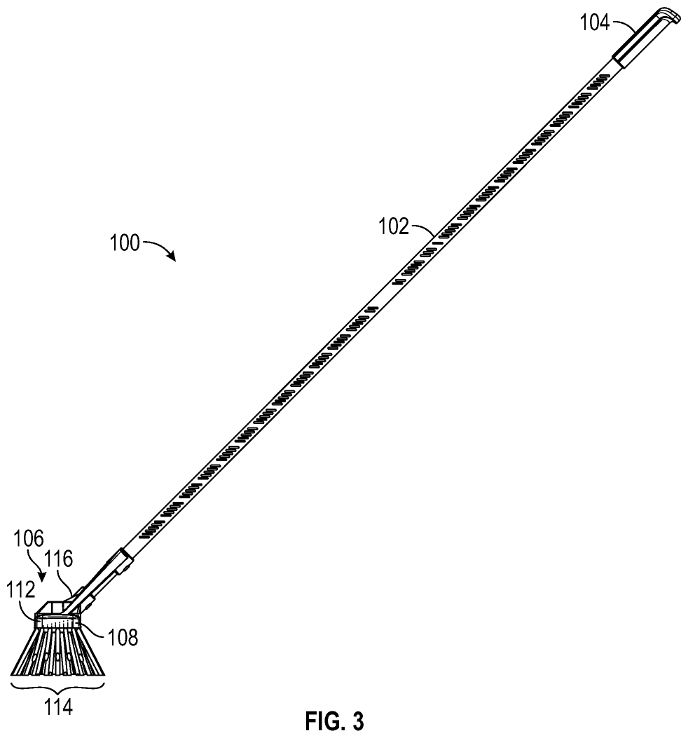

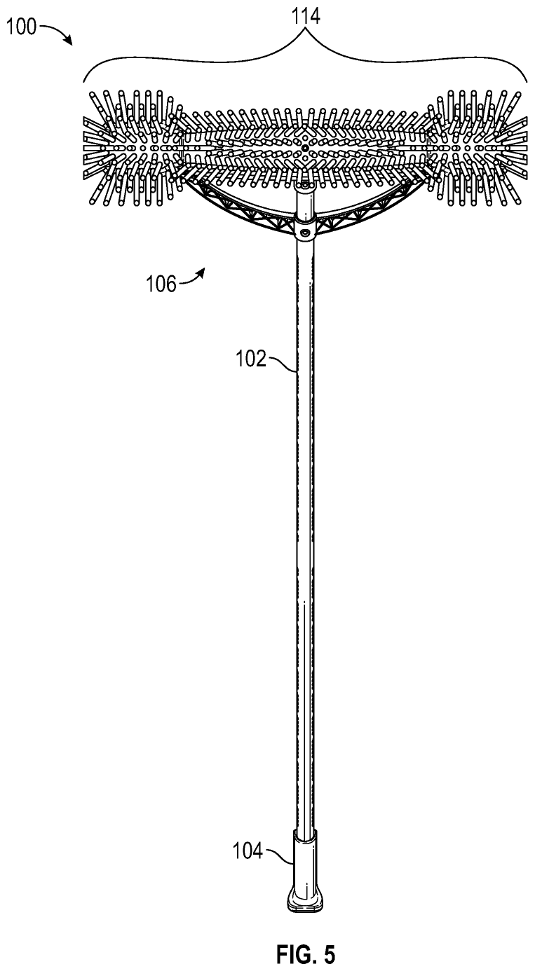

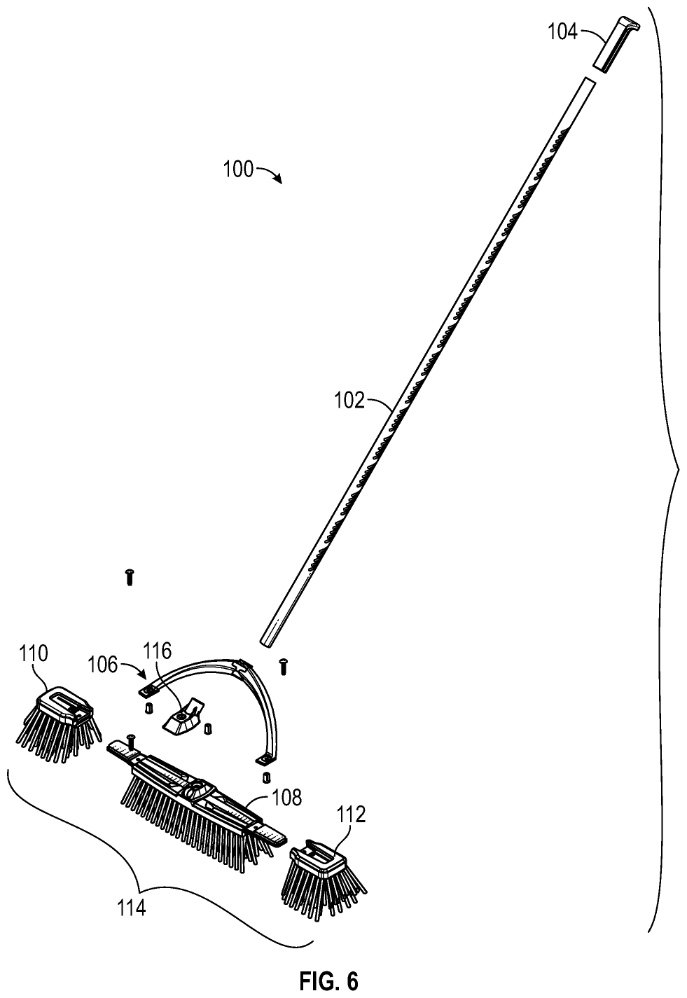

Referring now to FIG. 1-FIG. 7, a cleaning tool 100 (e.g., a broom) in accordance with an embodiment of the present disclosure is shown. The cleaning tool 100 includes a pole 102 (e.g., fixed pole or extendable pole) having a handle 104 on one end. The pole 102 may be made from any suitable material, such as, and without limitation, aluminum, fiberglass, or wood. Coupled to the pole 102, on an end opposite from the handle 104, is a head member assembly 106. The head member assembly 106 includes a center head member 108 and a pair of separately couplable end modules 110, 112. The center head member 108 and the end modules 110, 112 each have cleaning elements 114 (e.g., bristles). As will be described in more detail herein, and in some embodiments, the cleaning elements 114 may be formed from a plurality of bristle types, such a two-type, three-type, four-type, or more bristle types that are of different stiffness, diameter, bristle shape, flagged or unflagged, straight or crimped, material or a combination of the foregoing. It should be appreciated that in some embodiments, the cleaning elements 114 on the center head member 108 and the end modules 110, 112 may be the same.

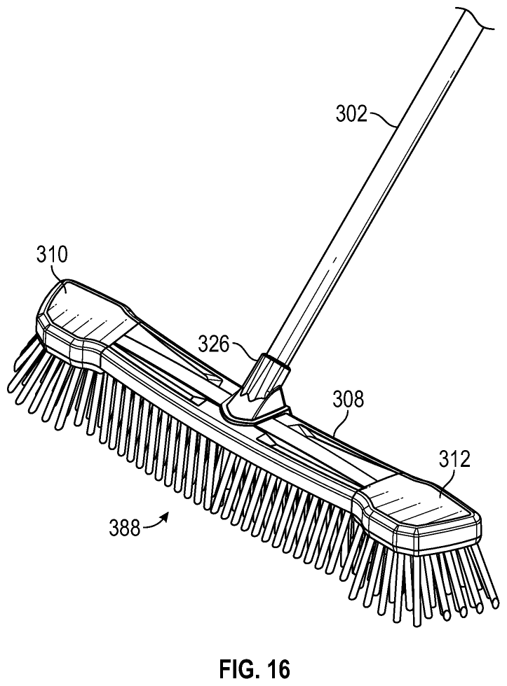

It should be appreciated that while the illustrated embodiment shows a single-type cleaning element, this is for clarity purposes and the claims should not be so limited. The illustrated cleaning elements or bristles may be comprised of a plurality of cleaning element or bristles that are bundled or grouped together into individual bristle elements. For example, in some embodiment, the cleaning elements 114 could be straight (FIG. 21A) or crimped (FIG. 21B). In an embodiment, each element of the cleaning elements 114 may have a diameter between less than 0.05 mm to more than 1.2 mm, and in an embodiment between 0.2 to 1 mm. Further, while embodiments herein refer to the bristle as having a diameter, it is contemplated that the cleaning elements may have other shapes, such as but not limited to round, triangular, quadrilobal, or rectangular for example. Further, the bristles may be flagged (e.g., having ends split) or unflagged. In other embodiments, the cleaning elements 114 may be replaced with a sponge or squeegee, rather than a bristle configuration.

The cleaning elements 114 may be made from a suitable material, such as, but not limited to, plastic/polymer materials, natural fibers, metals, or composites for example. In an embodiment, the cleaning elements 114 may be made from one or more of polyester, polypropylene, nylon, thermoplastic elastomer (TPE), polytetrafluoroethylene, boar hair, horsehair, Tampico fiber, Palmetto fiber, brass, steel, or carbon fibers for example. The bristles may further include additives to increase abrasiveness or to dissipate static electricity, such as but not limited to aluminum oxide.

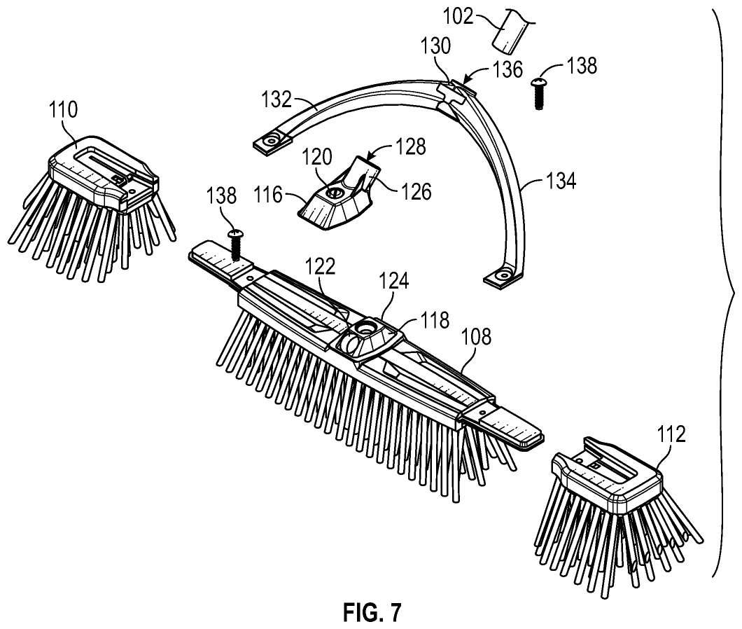

In an embodiment, the pole 102 is coupled to the center head member 108 by a bracket 116. The bracket 116 may be shaped to fit over a raised portion 118 (FIG. 7) on the center head member 108. The bracket 116 may be coupled to the raised portion 118 by a fastener 138 (e.g., screw, clip, detent pin, threads, snap configuration, pins, and the like). In an embodiment, the raised portion 118 includes a pair of angled holes 122, 124 that are disposed on a fixed predetermined angle, such as 40° to 45° from a surface being cleaned. In another embodiment, the angled holes 122, 124 are angled at 30° to 50°. In an embodiment, the bracket 116 includes a cylindrical projection 126 having a hole 128 that extends therethrough. The hole 128 is sized and positioned to be coaxial with one of the holes 122, 124, depending on the installation arrangement of the bracket 116 to the raised portion 118. The holes 122, 124, 128 are sized to receive an end of the pole 102. It should be appreciated that the bracket 116 is removably coupled to the raised portion 118 to allow the user to switch from using hole 124 to hole 122. This provides advantages in extending the life of the broom as the bristles may get deformed due to use in a single direction. To accommodate this, the end user can change the hole position and use the broom in an opposite direction. The positioning of the bracket 116 about the raised portion 118 may be aligned by a threaded hole 120 to receive the fastener 138 and attach the bracket 116 to the raised portion 118.

In an embodiment, the pole 102 may be coupled to the center head member 108 via a bracket 130 having a pair of arms 132, 134. The bracket 130 includes a hole 136 that is sized to receive the pole 102. When the bracket 130 is coupled to the center head member 108, the hole 136 is aligned coaxial with the hole 128 and one of the holes 122, 124. Ends of the arms 132, 134 may be coupled to the center head member 108 and/or the end modules 110, 112 by a fastener 138, such as screws that extend through the arms 132, 134, center head member 108 and end modules 110, 112 to couple all of the components together. In an embodiment, the fasteners 138 may engage a corresponding threaded insert in the end modules 110, 112. In an embodiment, the pole 102 may be coupled to the bracket 116 by fasteners such as screws, by threading directly into the center head member, with nuts, or molding in inserts for example.

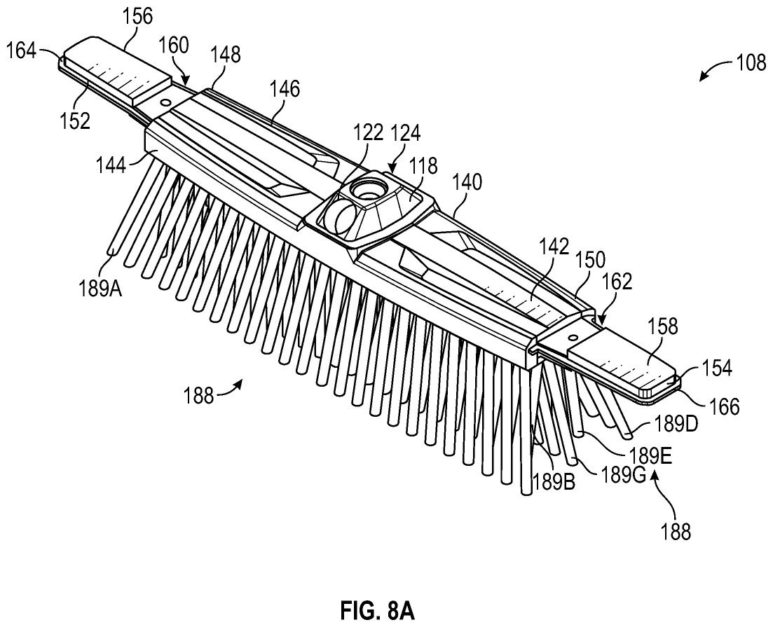

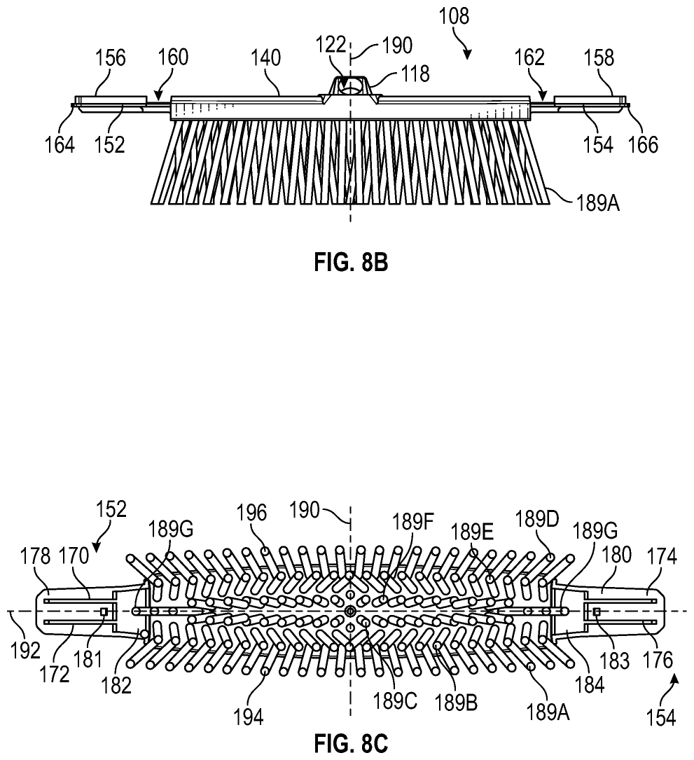

Referring now to FIGS. 8A-8C, an embodiment is shown of the center head member 108. The center head member 108 includes a body 140 having a top side 142. The top side 142 may include recesses and ribs and other structural and/or aesthetic elements for example. In an embodiment, a front side 144 and a rear side 146 of the center head member 108 are curved or arcuate. Extending from each end 148, 150 of the center head member 108 is a tongue member 152, 154. Each tongue member 152, 154 includes a projection 156, 158. In an embodiment, the projection 156, 158 define an optional slot 160, 162 that is sized to receive the ends of the arms 132, 134 of the bracket 130 (see, e.g., FIG. 7). In an embodiment, the projection 156, 158 defines a flange 164, 166 that extends about the periphery of the tongue members 152, 154, respectively. In the illustrated embodiment, the flange 164, 166 is sized to fit within a slot 168 in the end modules 110, 112 (FIG. 9A, FIG. 9H). In the illustrated embodiment and shown in FIG. 8C, the tongue members 152, 154 each include a pair of parallel ribs 170, 172, 174, 176 that extend from a bottom side 178, 180 of the respective tongue member 152, 154. The ribs 170, 172, 174, 176 are sized to fit in slots 182, 184 of the end modules 110, 112. In an embodiment, the tongue 152, 154 includes a second projection 152, 154 that is sized to be received in a recess 186 (FIG. 9A) in the end module 110, 112. In an embodiment, the bottom side 178, 180 further includes a tab 181, 183 sized and positioned to receive a recess 185 on the end modules 110, 112. In an embodiment, the tab 181, 183 and recess 185 cooperate as a snap-fit to hold or engage the end modules 110, 112 on or with the center head member 108.

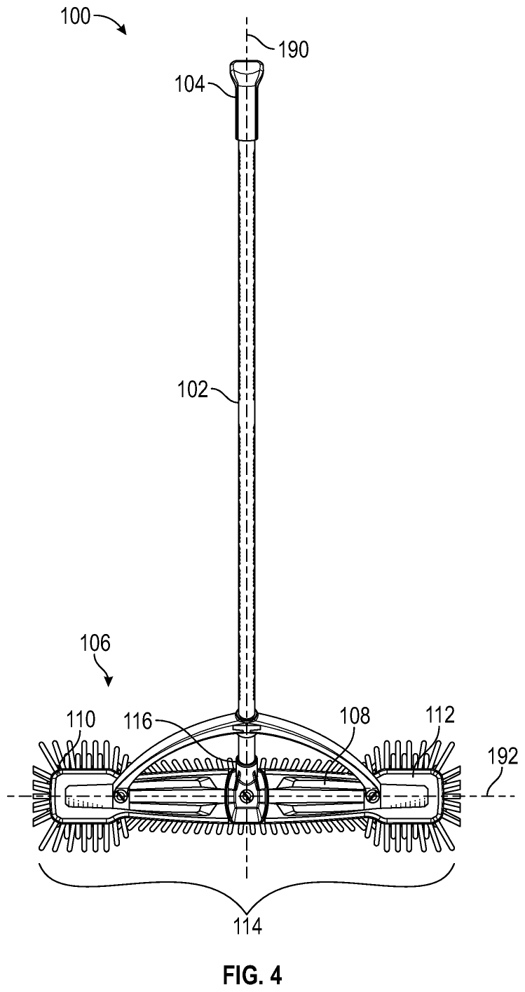

In the illustrated embodiment, the center head member 108 includes a plurality of rows of bristles 188. As will be discussed in more detail herein, the bristles 188 may be arranged on an angle relative to an axis or first centerline 190 (FIGS. 4, 8B) and/or a second centerline 192 (FIGS. 4, 8C). The first centerline 190 defines a plane that extends through the pole 102 and the head member assembly 106 (e.g., substantially perpendicular to a surface being cleaned). The second center line 192 defines a plane that extends through the middle of the center head member 108 (e.g., substantially perpendicular to the surface being cleaned and perpendicular to the first plane passing through the first centerline 190, the first plane extending into/out-of the page in the view of FIG. 4). In some embodiments, one or more of the rows of bristles 188 may have separate groups of bristles that are coupled on one end to the body 140. In some such embodiments, each of the separate groups of bristles may be disposed at a different angle relative to one or both of the planes passing through and defined by the centerlines 190, 192. The plane passing through centerline 192 extends into/out-of the page in the view of FIG. 4. In an embodiment, the angle of the bristles 188 relative to the plane defined by the first centerline 190 increases as the bristles 188 are positioned farther from the first centerline 190. In an embodiment, as shown in FIG. 8C, the bristles 188 are arranged in seven rows of bristles, with bristle rows 189A, 189B, 189C being on one side of the second centerline 192 and bristle rows 189D, 189E, 189F being on an opposite side of the second centerline 192. In an embodiment, the bristle rows 189A, 189B, 189C are symmetrical about the second centerline 192 with the bristle rows 189D, 189E, 189F. In an embodiment, a center bristle row 189G is disposed on or along the second centerline 192.

In an embodiment, each of the bristle rows 189A-189F is disposed on a different angle relative to an adjacent rows of bristles 189A-189F. In an embodiment, the bristle angles of adjacent rows are inverted relative to the plane defined by the first centerline 190 to provide a crisscrossing pattern when viewed from the bottom (FIG. 8B). In an embodiment, a distal end 194, 196 of the bristles 188 in the bristle rows 189A, 189D extends beyond the front side 144 and rear side 146 of the body 140, respectively. It should be appreciated that this allows the user to clean areas with the bristle rows 189A, 189D without interference from the body 140 of the central head member 108. For example, such extension of the outer bristle rows 189A, 189D enables cleaning in corners using the long side of the brush and dragging in along the edge.

Referring now to FIG. 8D, an embodiment of the center head member 108 is shown. In this embodiment, the bristle rows 189A, 189D for a first portion of bristles 196 having a first bristle characteristic, and the bristle rows 189B, 189C, 189E, 189F, 189G form a second portion of bristles having a second bristle characteristic. The bristle characteristic may be one or more of the bristle diameter, bristle shape, flagged/unflagged, straight/crimped, stiffness, material, or a combination thereof. In an embodiment, the first bristle characteristic is different from the second bristle characteristic. It should be appreciated that while embodiments herein may refer to the center head member 108 as having one (1-type) or two different (2-type) bristle characteristics, this is for example purposes and the claims should not be so limited. For example, in other embodiments, the center head member 108 may include 3-type, 4-type, 5-type, or more different types of bristles with different bristle characteristics. Further, it is contemplated that each bristle bundle may include different bristle types having different bristle characteristics.

Referring to FIG. 8E, an embodiment is shown of the center head member 108. In this embodiment, the proximate end (the end at the bottom side of the body 140) of each of the rows of bristles 189A-189C are offset relative to the adjacent bristle in the rows 189A-189C. Similarly, the proximate end of the each of the rows of bristles 189D′-189F′ are offset relative the adjacent bristles in rows 189D′-189F′. For example, the bristle 189D′ is offset from the plane of the first centerline 190 by a first distance D1, the bristle 189F′ is offset from the plane of the first centerline 190 a second distance D2, and the bristle 189E′ is offset from the plane of the first centerline 190 a third distance D3. In this configuration, the distances D1, D2, D3 are increasing such that D3>D2>D1. In an embodiment, the bristles within a given row 189A-189G are equally spaced apart along the length of the row.

Referring now to FIGS. 9A-9B, an embodiment is shown of an end module 112. It should be appreciated that while the illustrated embodiments only shows one end module 112, the other end module 110 is constructed in the same manner. The end module 112, as shown, includes a body 200 having a top surface 202, a bottom surface 204, an end surface 206, a front surface 208, and a rear surface 210. The body 200 includes recesses 163, 186 formed in the top surface 202. As discussed herein, when the end module 112 is assembled onto a tongue member 154 of a center head member 108, a flange 166 is received within the slot 168 and ribs 174, 176 of the tongue member 154 are received within the slots 182, 184 of the end module 112. The end module 112 is configured to slide on the tongue member 154 such that a tab 183 of the tongue member 154 is slid into a recess 185 of the end module 112.

In an embodiment, the engagement of the tab 183 into the recess 185 provides a first coupling of the end module 112 to the center head member 108 and also aligns an opening 212 in the recess 186 with an opening 214 in the tongue member 154 (e.g., within an optional slot 162). This allows a fastener 138 to be inserted to secure the end module 112 to the center head member 108. In an embodiment, a threaded insert is disposed within the opening 212 of the end module 112 that is sized to receive and couple with the fastener 138. In other embodiments, the fastener 138 is omitted and the end module 112 is coupled to the center head member 108 by a snap-fit of the tab 183 with the recess 185. In some embodiments, the end module 112 is configured to be easily removed from the center head member 108 to allow interchanging of different end modules 112 (e.g., different size, shape, bristle configuration, etc.). In other embodiments, the end modules 110, 112 may be fastened to the center head module 108 using other fastening means, such as but not limited to press fit, adhesive bonding, ultrasonic welding, or a combination of the foregoing. Different end modules 112 may have different bristles, different combinations of bristles, bristles having different lengths or disposed on/at different angles, different length (e.g., to make the cleaning tool 100 wider), or a combination of the foregoing. Thus, the user may select an end module 112 from a plurality of end modules, each of which is suitable for a different cleaning task or environment.

In an embodiment, and as shown in FIG. 9C, the body 200 of the end module 112 may include an angled surface 216 arranged between the sides 206, 208, 210 and the bottom surface 204. The angled surface 216 provides a surface for the bristles, such as a row of bristles 218A for example, to extend out at an angle relative to the sides 206, 208, 210. Further, in some embodiments, a thickness “TB” of the body 140 of the center head member 108 is less than the thickness “TE” of the body 200 of the end module 112. This allows for the forming of holes on an angle in the body 200 to allow the bristles of the end module 112 to extend past the side 206, 208, 210, while giving enough depth for the bristles to be held/supported in the center head member 108/end module 112 and held, for example, with a staple. It should be appreciated that the bristles may also be coupled to the center head member 108 or end modules 110, 112 using other fastening means, such as but not limited to adhesive bonding or ultrasonic welding, for example.

Referring now to FIG. 9D, an embodiment is shown of the plurality bristles extending from the bottom surface 204 of the end module 112. In an embodiment, the bristles are comprised of a plurality of bristle rows 218A-218K. The bristle rows 218A-218D are disposed on one side of the plane defined by the second centerline 192, while the bristle rows 218H-218K are disposed symmetrically on an opposite side of the plane defined by the second centerline 192. The center of the bristle row 218E is disposed substantially co-planar with the plane defined by the second centerline 192. The bristle rows 218E, 218F extend on angles away from the plane defined by the first centerline 190 adjacent the end surface 206. It should be appreciated that other bristle row patterns are contemplated.

In the illustrated embodiment, the bristle rows 218A-218D, 218H-218K are arranged on an angle relative to the plane defined by the second centerline 192, with the distal end of each bristle being further away from the plane defined by the second centerline 192 than the proximate end (e.g., the end adjacent the surface 204). In the illustrated embodiment, the distal ends of the bristle rows 218A, 218B, 218H, 218I extend beyond the sides 208, 210 respectively. It should be appreciated that at least some of the bristles 218A-218D, 218H-218K may be oriented on an angle relative to the plane defined by the first centerline 190. In an embodiment, the distal ends of bristle rows 218A, 218B, and bristle rows 218H, 218I are disposed on an angle A1 (FIG. 9F) such that the distal ends of bristles 218A, 218B, 218H, 218I extend beyond the front surface 208 and the rear surface 210. In other words, the horizontal or perpendicular distance D4, D4′ to the distal end is greater than the horizontal or perpendicular distance D5 to the surfaces 208, 210. In an embodiment, the distance D4 is different than the distance D4′. In an embodiment, the distance D4 is between 0.7 to 4 inches, the distance D5 is between 0.75 to 2 inches, while the angle A1 is between 130-160 degrees. In another embodiment the angle A1 is 90 to 180 degrees,

Similarly, the bristle rows 218E, 218F are disposed on an angle relative to the plane defined by the first centerline 190 such that the distal ends of the bristle rows 218E, 218F are on an angle A2 (FIG. 9E). In one non-limiting embodiment, the angle A2 is between 130 to 160 degrees and in another embodiment between 90 to 180 degrees to extend beyond the end surface 206. In other words, a perpendicular or horizontal distance D6 from the plane defined by the first centerline 190 to the end surface 206 is less than a perpendicular or horizontal distance D7 from the plane defined by the first centerline 190 to the distal end of the bristle rows 218E, 218F. In an embodiment, the distal ends of the bristle row 218F are trimmed on an angle to be substantially parallel to the plane defined by the first centerline 190. In one embodiment the distance D6 is between 6 to 18 inches. In one embodiment the distance D7 is between 6.5 to 22 inches.

It should be appreciated that the angling or flaring of the bristles outward relative to the surfaces 206, 208, 210 provides advantages in facilitating the cleaning of corners, such as at the intersection of a wall and a floor for example, or to reach under lips and edges of structures, such as counters and the like.

In an embodiment, the bristle rows 218A, 218B, 218F, 218H, 218G form a third portion of bristles 220 (FIG. 9D) having a third bristle characteristic, and the bristle rows 218C, 218D, 218E, 218J, 218K form a fourth portion of bristles 222 having a fourth bristle characteristic. The bristle characteristic may be one or more of the bristle diameter, stiffness, flagged/unflagged, straight/crimped, material, or a combination thereof. In an embodiment, the third bristle characteristic is different than the fourth bristle characteristic. In an embodiment, the third bristle characteristic is the same as the first bristle characteristic, and the fourth bristle characteristic is the same as the second bristle characteristic. In still another embodiment, each of the first bristle characteristic, the second bristle characteristic, the third bristle characteristic, and the fourth bristle characteristic are different from each other (e.g., four different bristle types). It should be appreciated that the bristle portions 196, 189, 220, 222 may be further divided into sub-portions with different characteristics. For example, the bristle rows 218F, 218G may be a distinct bristle portion for bristle rows 218A, 218B. It should be appreciated that while embodiments herein may refer to the bristle rows 218A-218L as having one or two different bristle characteristics, this is for example purposes and the claims should not be so limited. In other embodiments, the bristles coupled to the end modules may include 3-, 4-, 5-, or more different types of bristles with different bristle characteristics. Further, it is contemplated that each bristle bundle may include different bristle types having different bristle characteristics.

Referring now to FIG. 9G, an embodiment is shown wherein the bristles extend on to the end surface 206 of end modules 210, 212. In this embodiment, the end module 212 may include one or more rows 224 that extend in a direction away from the plane defined by the first centerline 190. Thus, the head member assembly 106 may include bristles on a plurality of angles A1, A2, A3 (FIG. 9G) relative to the plane defined by the first centerline 190 from 90 degrees (e.g., perpendicular to the plane defined by the first centerline 190) and zero degrees (e.g., parallel to the plane defined by the first centerline 190), inclusive. Further, the bristles may be on a plurality of angles relative to the plane defined by the second centerline 192 from 90 degrees (e.g., perpendicular to the plane defined by the second centerline 192) to zero degrees (e.g., parallel to the plane defined by the second centerline 192), inclusive. In an embodiment, the angles A1, A2, A3 may be less than 90 degrees and greater than zero degrees.

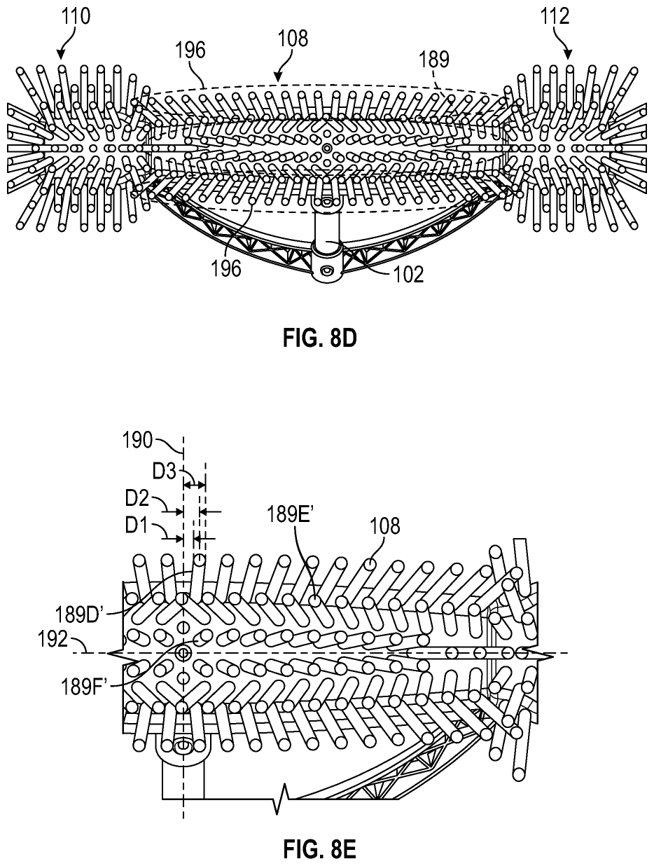

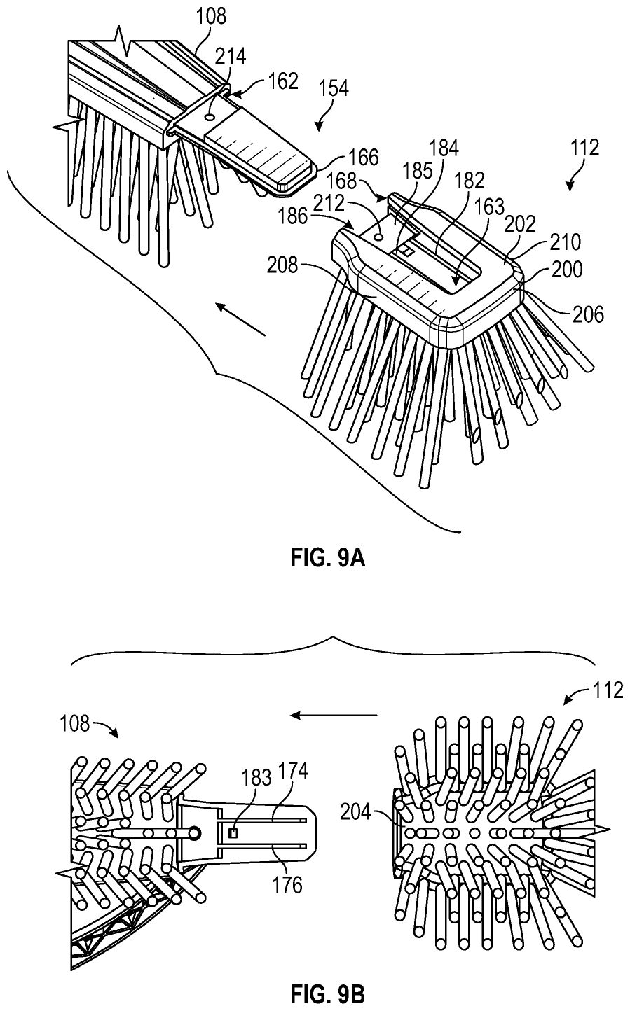

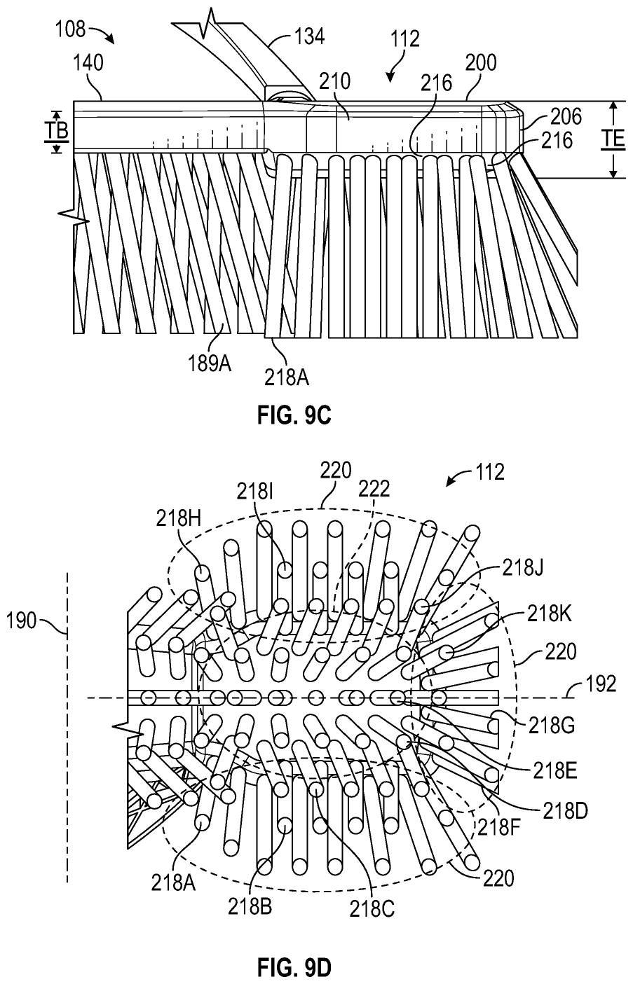

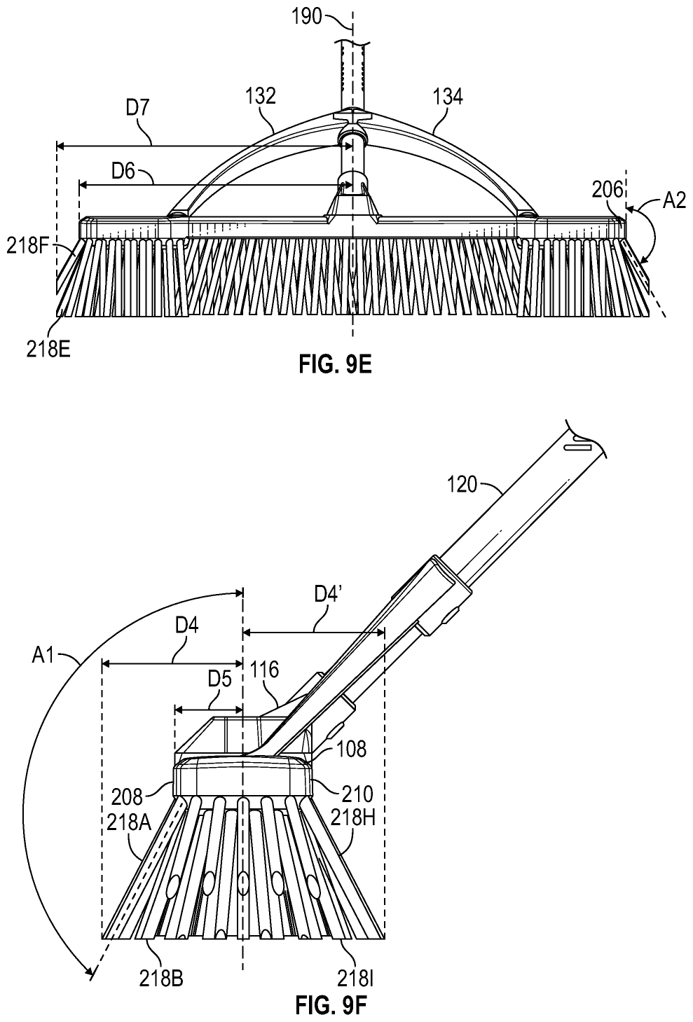

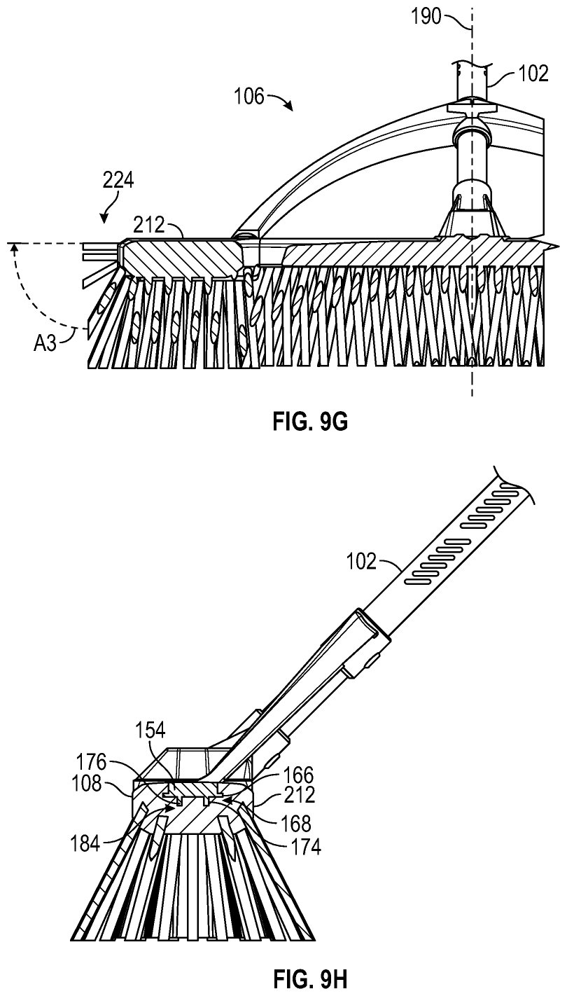

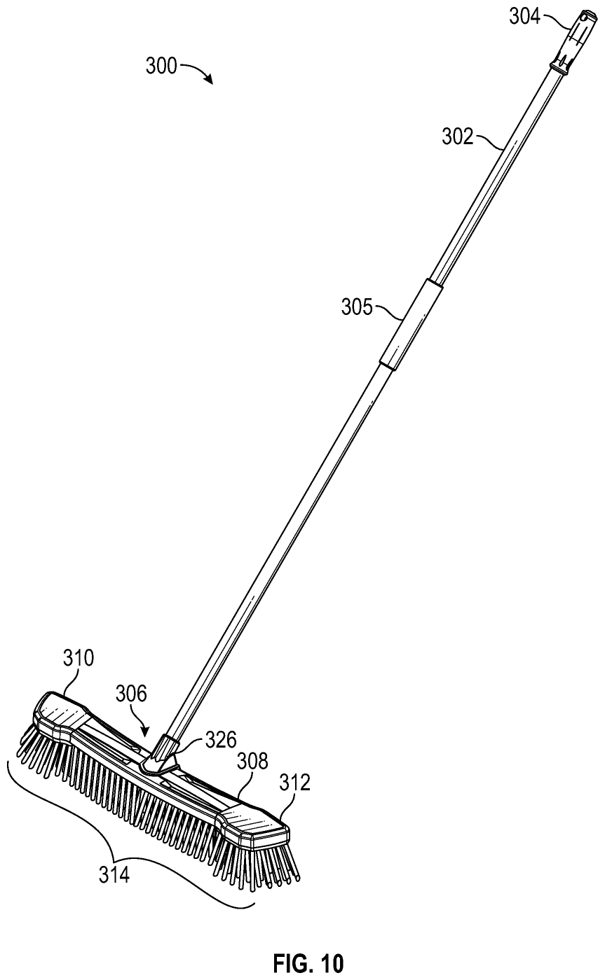

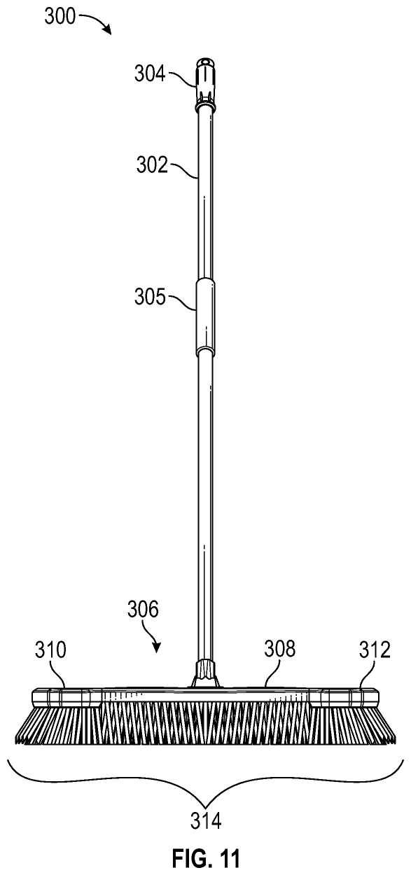

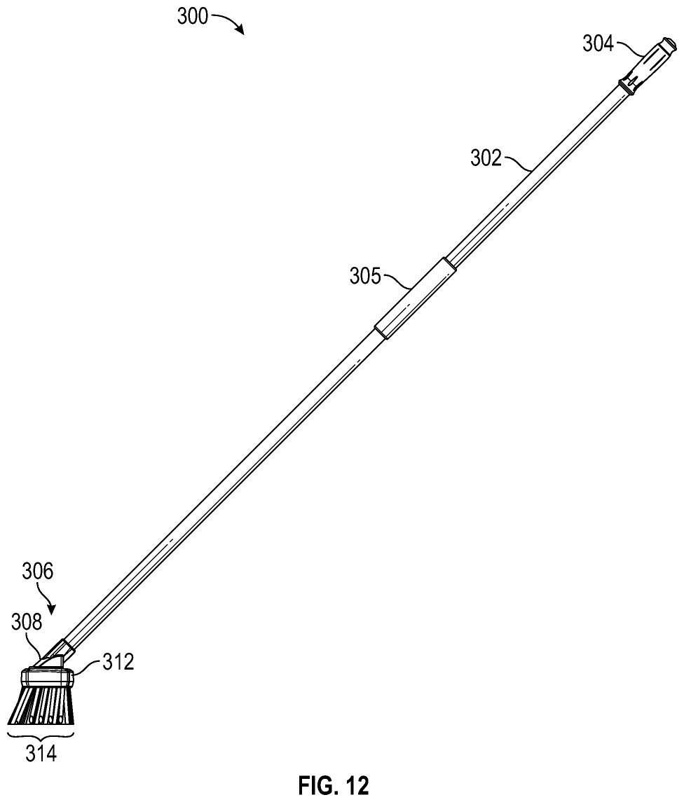

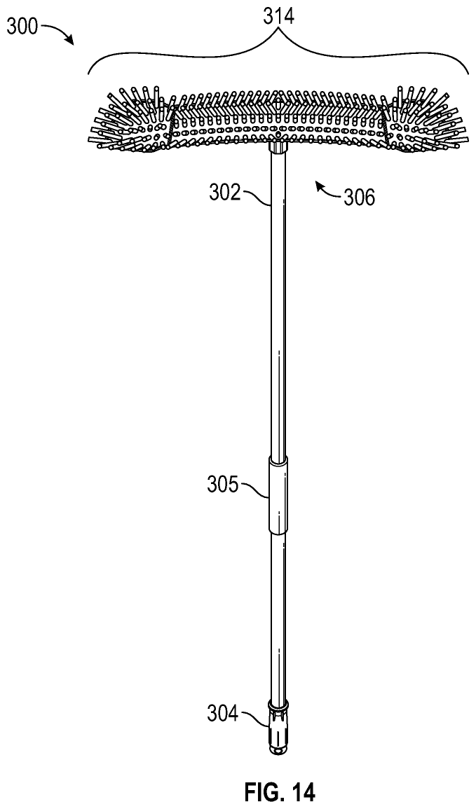

Referring now to FIGS. 10-20, another embodiment of a cleaning tool 300 (e.g., a broom) are shown. The cleaning tool 300 includes a pole 302 having a handle 304 on one end. In an embodiment, the pole 302 may be the pole described in concurrently filed U.S. application Ser. No. 16/796,414, filed on Feb. 20, 2020, entitled “Ergonomic Pole,” the contents of which are incorporated herein by reference. In an embodiment, a grip member 305 is coupled to the pole 302 offset a predetermined distance from the handle 304. The grip member 305 may be fixed or movable by the user along the length of the pole 302. Coupled to the pole 302, on an end opposite the handle 304, is a head member assembly 306. In an embodiment, the pole 302 includes a threaded end 303 (FIG. 15) that couples with a threaded opening 328 in a cylindrical projection 326 that extends from a top side of a central head member 308 of the head member assembly 306. In an embodiment, the cylindrical projection 326 is integrally molded into the central head member 308. In another embodiment, the cylindrical projection may be formed by a bracket that is coupled to the central head member 308. A pair of opposing end modules 310, 312 are slidably or releasably coupled to the central head member 308. Extending from a side of the central head member 308 and end modules 310, 312 are a plurality of cleaning elements or bristles 314.

In an embodiment, the end modules 310, 312 are coupled to the central head member 308 by fasteners 338. In an embodiment, the fasteners 338 are inserted through a bottom surface of the end modules 310, 312 to engage with tongue members 352, 354 of the central head element 308.

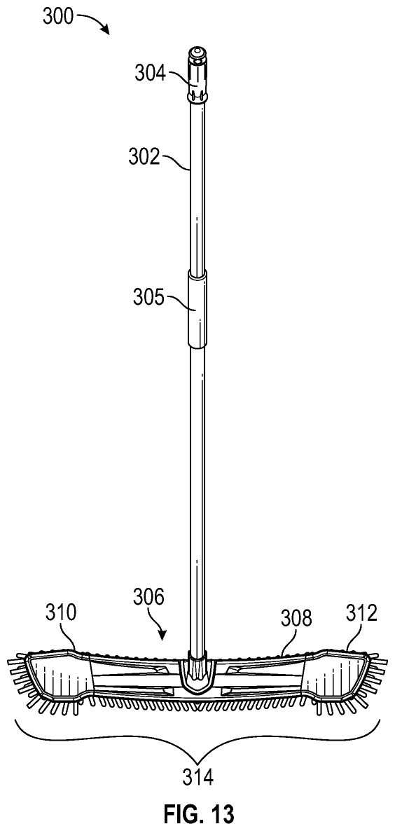

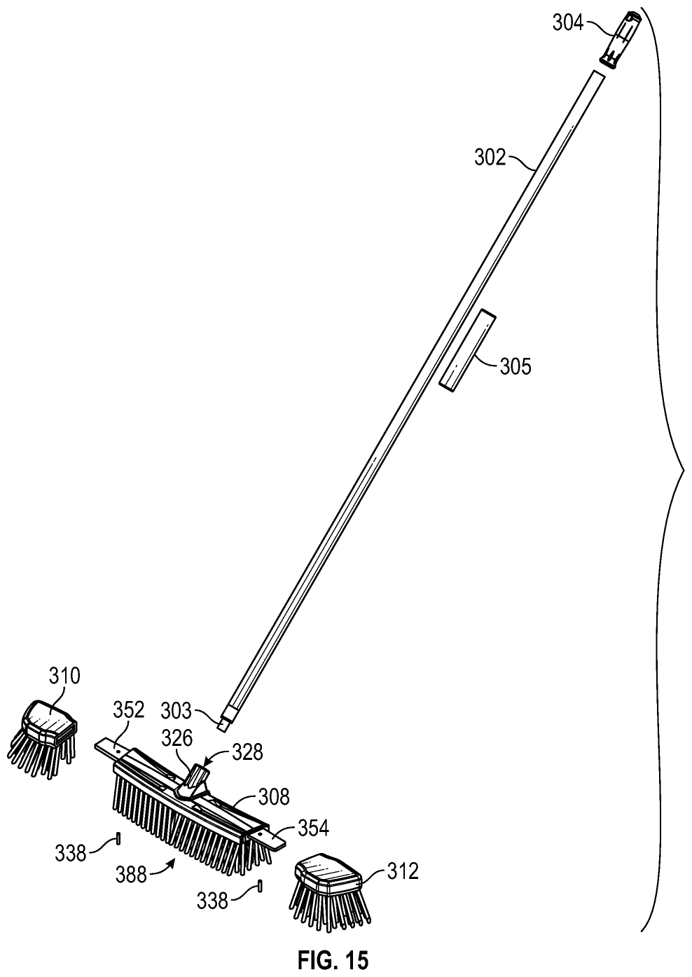

In an embodiment, and as shown in FIG. 15, the central head member 308 includes a pair of tongue members 352, 354. The tongue members 352, 354 are generally planar and include a pair of ribs 374, 376 (FIG. 20) disposed on a bottom side of the respective tongue member 352, 354 (e.g., adjacent the bristles 314). The tongue member 354 is sized to fit in a slot 363 of the end module 312 (FIG. 18). The slot 363 includes a pair of slots 382, 384 that are sized and positioned to receive the ribs 374, 376. When the end module 312 is fully inserted over the tongue member 354, an opening 315 in the tongue member 354 is aligned with an opening 317 in the end module 312 allowing the fastener 338 to be inserted and couple the end module 312 to central head member 308. In other embodiments, the end module 312 may be coupled to the center head member 308 by other fastening means, such as but not limited to a bolt or screw with a threaded insert, snap-fit, adhesive bonding, ultrasonic welding, or a rivet for example. It should be appreciated that while the end module 312 and tongue member 354 are described herein, the end module 310 and tongue member 352 are constructed in the same manner.

Similar to the cleaning tool 100, the central head member 308 of this embodiment includes a plurality of bristles 388 that are arranged in a plurality of rows. In an embodiment, the bristles 388 may be arranged in the same manner as the bristles 188. The bristles 388 may be comprised of a portion 396 of bristles having a first bristle characteristic and a second portion 398 of bristles having a second bristle characteristic. In an embodiment, the first bristle characteristic is different than the second bristle characteristic. In another embodiment, the first bristle characteristic is the same as the second bristle characteristic. It should be appreciated that while embodiments herein may refer to the bristle 388 as having one or two different types of bristle characteristics, this is for example purposes and the claims should not be so limited. In other embodiments, the bristles 388 coupled to the center head member 308 may include 3-, 4-, 5-, or more different types of bristles with different bristle characteristics. Further, it is contemplated that each bristle bundle may include different bristle types having different bristle characteristics.

The end modules 310, 312 each include a plurality of bristles 418. In an embodiment, the bristles 418 are configured the same as the bristles of end module 112. The bristles 418 are arranged in a plurality of rows. In an embodiment, the rows may be comprised of a third portion of bristles having a third bristle characteristic and a fourth portion of bristles having a fourth bristle characteristic. In an embodiment, the third bristle characteristic is different than the fourth bristle characteristic. In another embodiment, the third bristle characteristic is the same as the fourth bristle characteristic. In an embodiment, the first bristle characteristic, the second bristle characteristic, the third bristle characteristic, and the fourth bristle characteristic are all different. It should be appreciated that while embodiments herein may refer to the bristles 418 as having one or two different bristle characteristics, this is for example purposes and the claims should not be so limited. In other embodiments, the bristles 418 coupled to the end modules may include 3-, 4-, 5-, or more different types of bristles with different bristle characteristics. Further, it is contemplated that each bristle bundle may include different bristle types having different bristle characteristics.

In an embodiment, the bristles 388 and the bristles 418 may be configured the same as cleaning tool 100 with the bristles in the rows on the periphery each extending on an angle such that each distal end extends beyond the front, rear and end surfaces of the central head member 308 and the end modules 310, 312. As discussed herein, this provides advantages in facilitating the cleaning of corners, such as the base of a wall for example.

As discussed above, the pole to be used with the cleaning head assemblies may be a straight pole or may be an ergonomic pole. Such ergonomic poles may be used with implements, such as cleaning implements, squeegees, brooms, brushes, mops, plows, or poles, which allow a user to provide forces in desired direction(s)/vector(s) without substantially bending their back during normal operation. Embodiments of the present disclosure further provide for an ergonomic pole for use with implements that has an adjustable length to accommodate a user's height.

Ergonomic poles have been proposed for use with tools, such as snow shovels for example. These poles allow a user to lift material (e.g., snow or dirt) without having the user bending as far down, allowing them to more efficiently use their legs in a lifting motion to reduce stain on their back. Further, the shape of the pole allows the user to place their hands close to the shovel end for stability. These lifting ergonomic poles are unsuitable for use with other types of cleaning implements, such as brooms or squeegees. For these types of cleaning implements, the user is not lifting material, but rather is placing a downward force and/or a forward force simultaneously while in use. Unlike a shovel which has intermittent usage, the forces on a broom or squeegee are more continuous. Further, some cleaning implements such as squeegees are held within a predetermined angle during use for efficient operation. When a squeegee is held outside of this angular range, the squeegee blade may chatter or bounce, causing portions of the liquids being removed to be left behind or have an increased force required to push the squeegee forward to clean/move the material/debris.

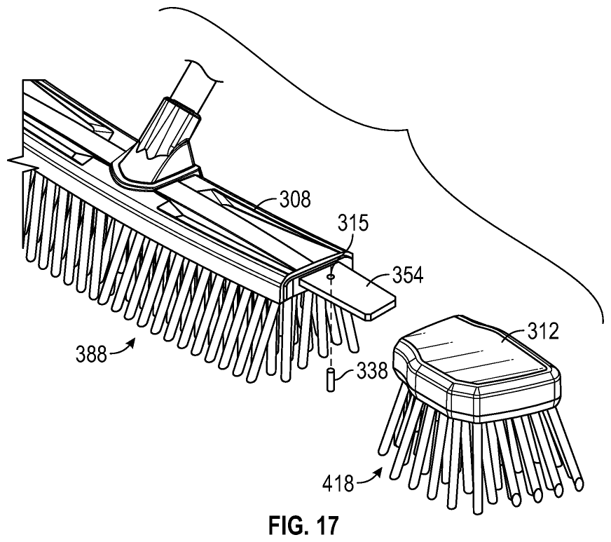

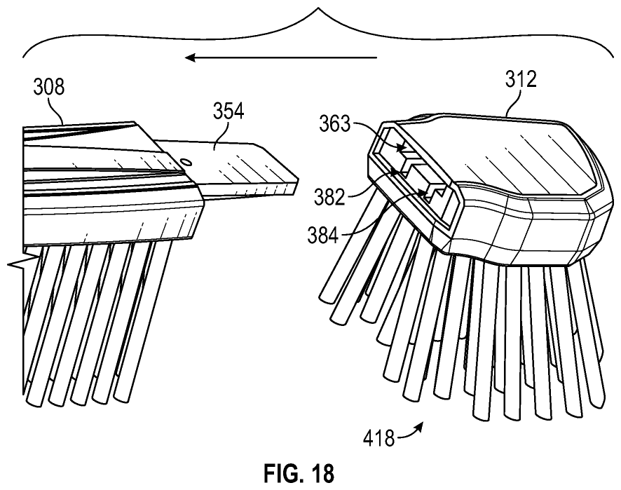

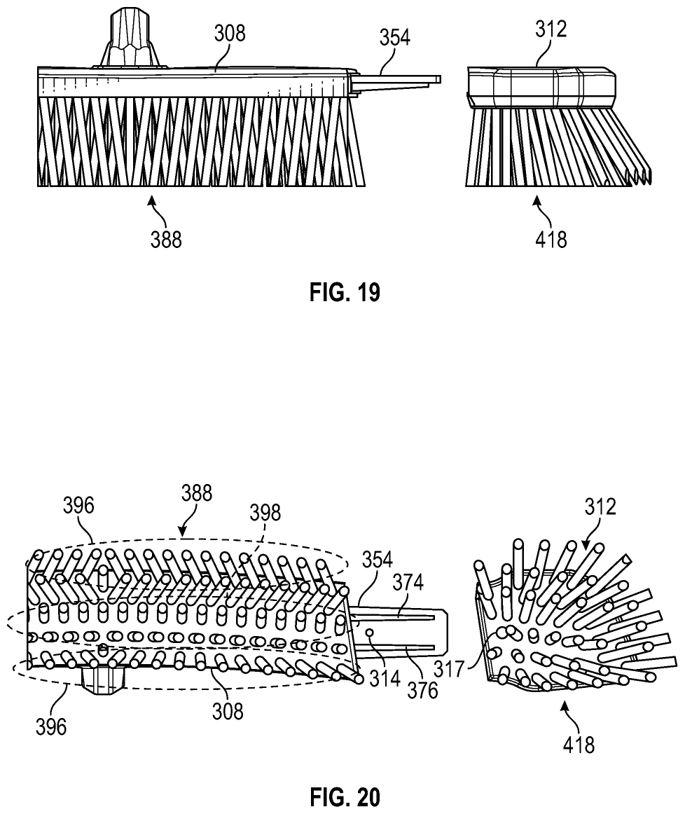

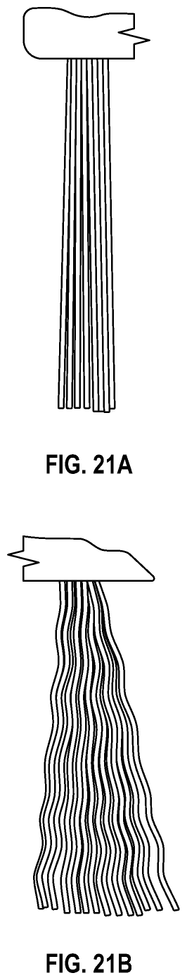

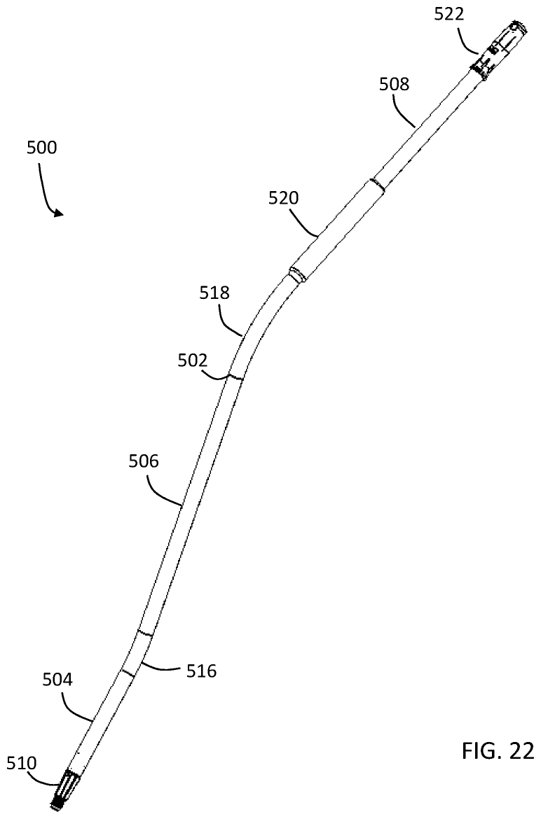

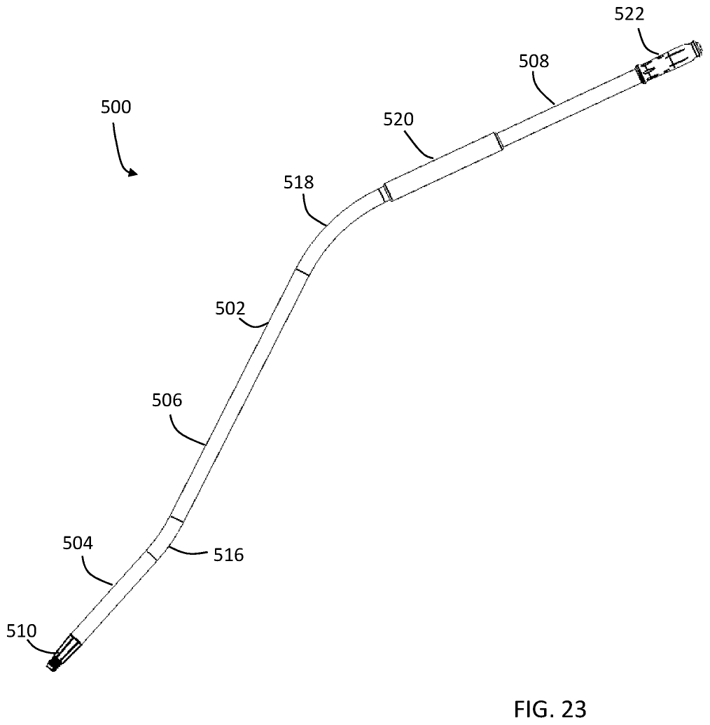

Referring now to FIGS. 22-29, an embodiment is shown of an ergonomic pole 500 for use with implements, such as cleaning implements and cleaning tools as shown and described above. The pole 500 includes an elongated cylindrical member 502. In the illustrated embodiment, the member 502 is a thin walled tubular member made from a material, such as but not limited to: aluminum, steel, metallic alloys, fiberglass, carbon fiber and epoxy, or wood or a combination of the foregoing with or without grips, texture, or surface treatments. It should be appreciated that other materials, such as a plastic/polymer material or a combination of plastic and metal for example. It should further be appreciated that while embodiments herein may describe the member 502 as being tubular or hollow, this is for example reasons and the claims should not be so limited. In other embodiments, the member 502 may be made from a solid material. It is also contemplated that the cross section can be other than cylindrical, such as oval, trilobal, squared, etc. The exterior surface of the member 502 can also be textured and/or have grips attached, such as with adhesive and/or fastener.

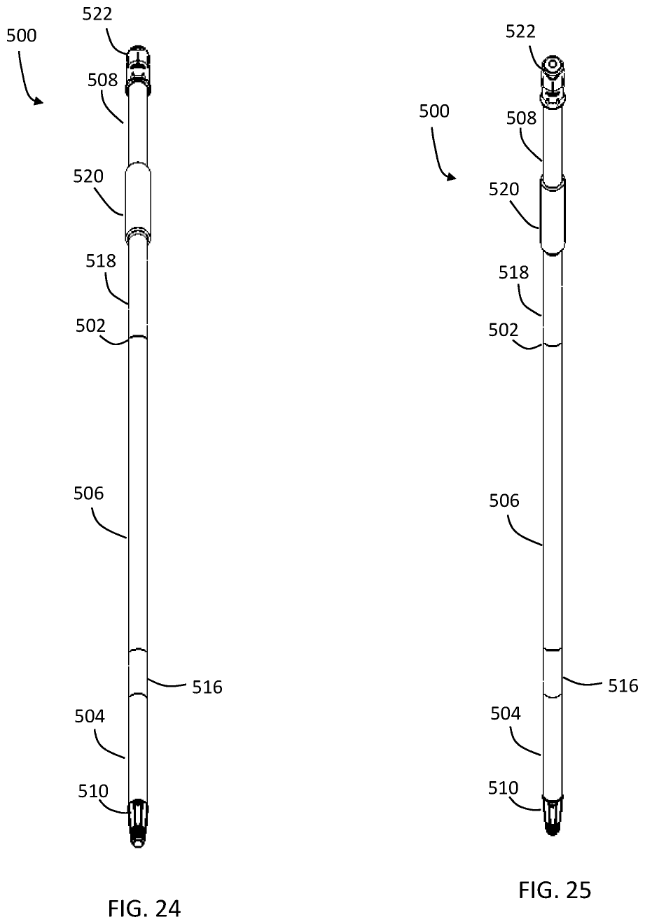

In the illustrated embodiment, the member 502 is comprised of a plurality of straight segments connected by curved segments. The straight segments are arranged to facilitate placing the implement at the desired orientation (e.g., an angle relative to a surface to be cleaned) while allowing the user to push on the pole 500 and keep their back straight or substantially straight (e.g., not bent or hunched over) while making it easy (improving) to get the correct pushing (forward) and cleaning (downward) forces. In this illustrative embodiment, the member 502 includes a first straight segment 504, a second straight segment 506, and a third straight segment 508. Coupled to the first straight segment 504 is a coupler 510. In an embodiment, the coupler 510 is configured to engage a corresponding member on the implement and secure the implement to the pole 500 (e.g., bracket 116). In the illustrated embodiment, the coupler 510 has a threaded portion 512 and a cone portion 511 (FIG. 28C), however, any suitable coupling mechanism may be used. In an embodiment, the coupler 510 is removably coupled to the member 502 to allow a coupler with a different attachment means to be used. In the illustrated embodiment, the coupler 510 includes a cylindrical portion 514 sized to be received within the first straight segment 504. The coupler 510 may be secured to the first straight segment 504 by a fastener (not shown), detent pin, snap-fit, or the like.

The second straight segment 506 is coupled to the first straight segment 504 by a first curved segment 516. In the illustrated embodiment, the radius and center of the curved segment 516 is sized and positioned such that the first straight segment 504 and the second straight segment 506 extend tangentially from the curved segment 516.

The second straight segment 506 is coupled to the third straight segment 508 by a second curved segment 518. In the illustrated embodiment, the radius and center of the second curved segment 518 is selected such that the second straight segment 506 and the third straight segment 508 extend tangentially from the second curved segment 518.

Coupled to the third straight segment 508 is a grip member 520. The grip member 520 is made from a material that allows the user to comfortably hold the grip member 520 for periods of use. The grip member 520 may be made from a material such as foam, thermoplastic elastomer (TPE), plastic, or the like. The grip member 520 could be smooth or have finger grips or may have a contoured outer surface that is shaped to allow a user to comfortably hold and apply force to the pole 500. In an embodiment, the grip member 520 may be movable along the length of the third straight segment 508 by the user. In an embodiment, the grip member 520 may be moved further down along the pole 500 onto the second curved member 518 or even the second straight segment 506 if desired by the user. Also coupled to the end of the third straight member 508 is a handle 522. The handle 522 includes an opening 524 on one end sized to receive an end of the third straight segment 508. The handle 522 includes a contoured outer surface 526 that is shaped to allow the user to comfortably hold and apply force to the pole 500. An end 528 of the handle 522 may be curved to allow a user to comfortably place their palm on the end 528, if desired during use. In an embodiment, the handle 522 may include a hole 530 that extends therethrough adjacent the end 528. The hole 530 may be provided to enable hanging of the pole 500 when not in use and/or to tie a loop of rope or string therethrough, for example.

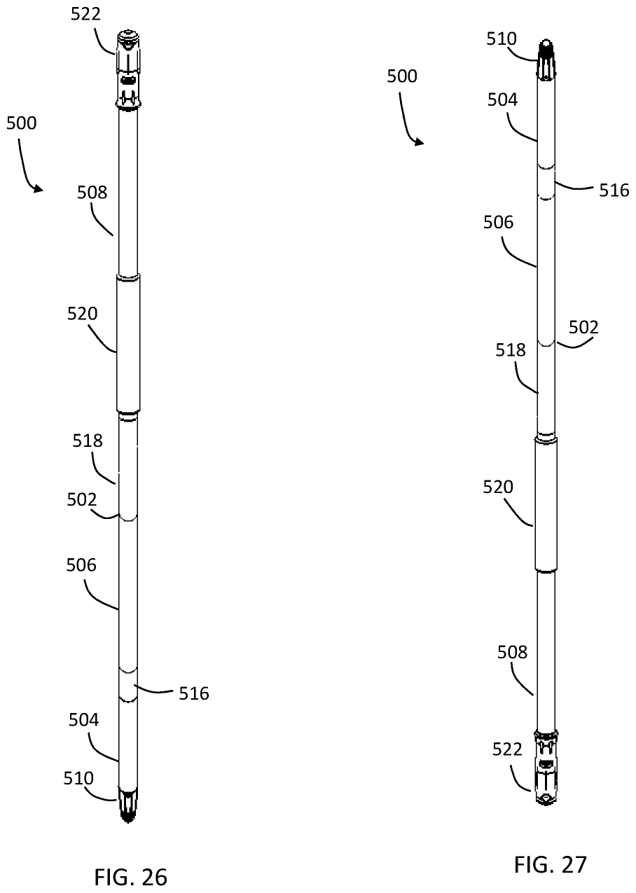

The proportions of the segments 504, 506, 508, 516, 518, 520, 522 of the pole 500 will be discussed herein with respect to Table 1, below. The sizes and proportions are selected to provide a desired height H and length L while maintaining the first segment 504 at the desired angle A₁ to place the implement 532 (FIG. 29) at the desired orientation to the work surface. The implement 532 may be a cleaning tool such as shown and described above, for example, although other cleaning tools may be used without departing from the scope of the present disclosure. The angle A₁ is sometimes referred to as the functional angle as it is the angle of the first segment 504 that places the implement 532 at a desired orientation/angle.

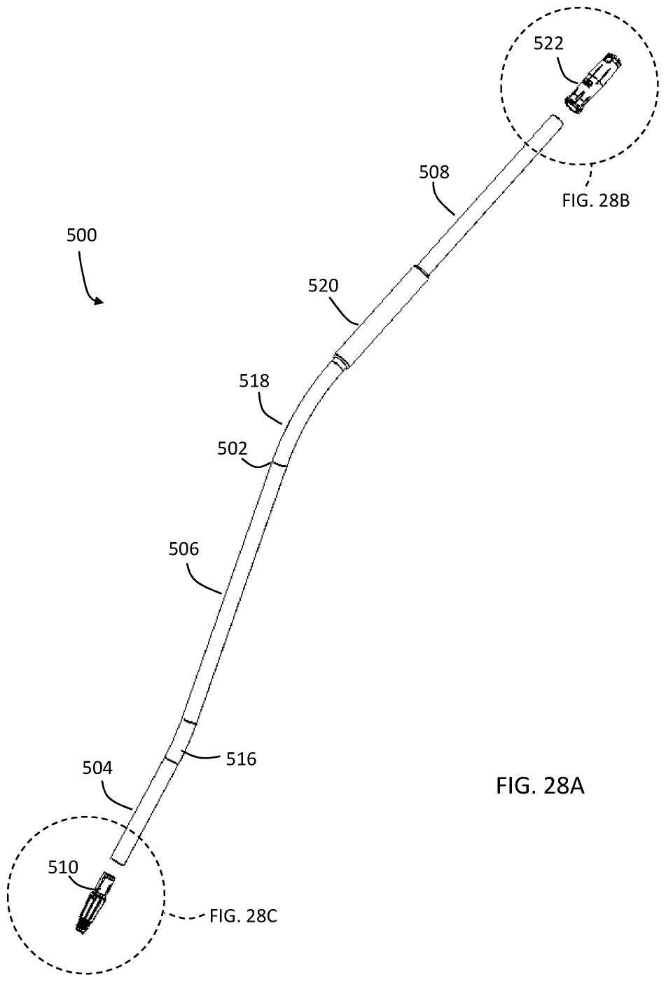

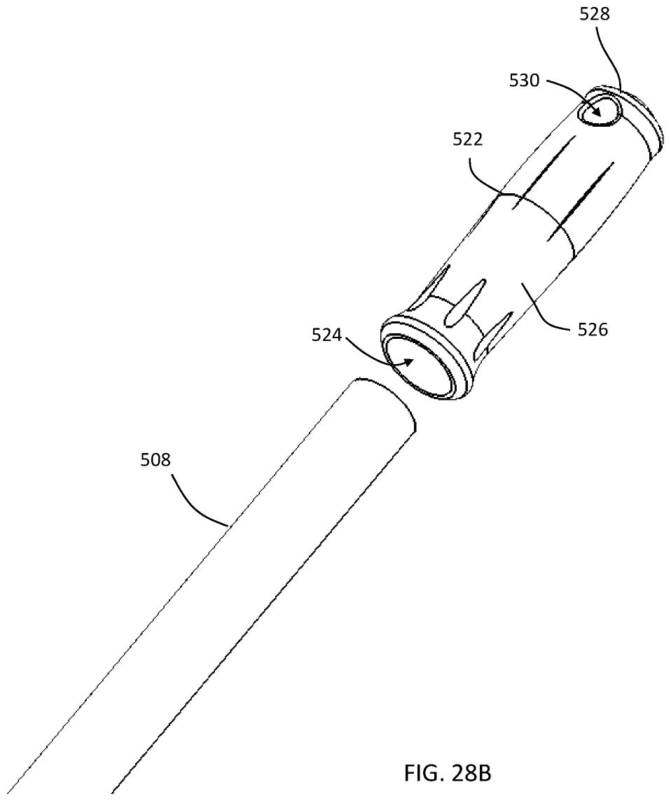

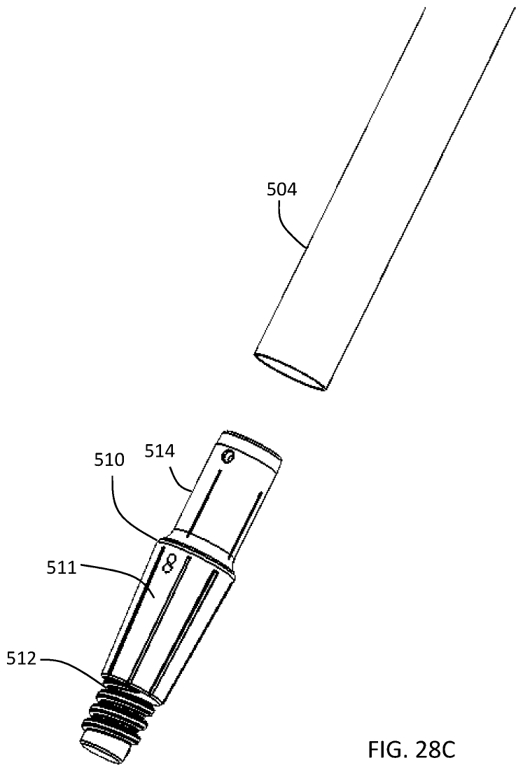

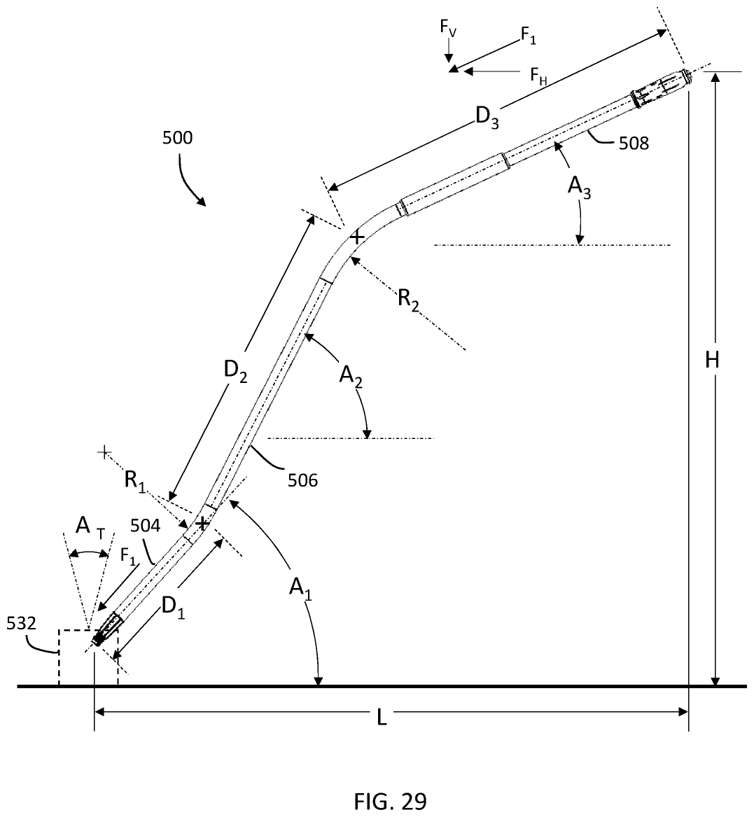

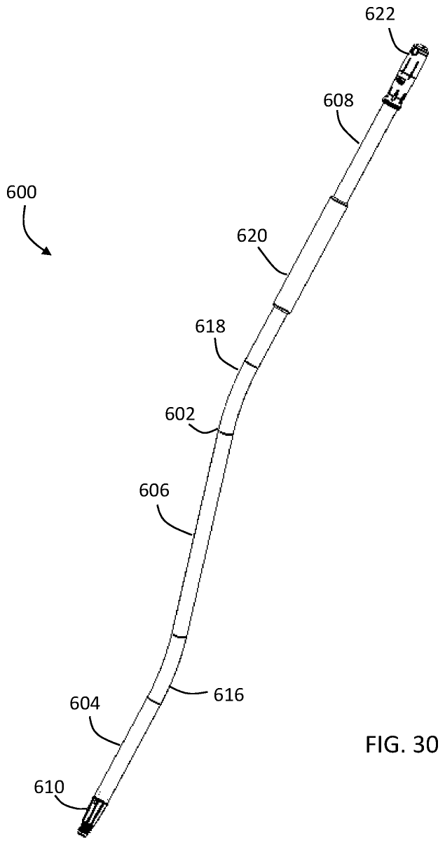

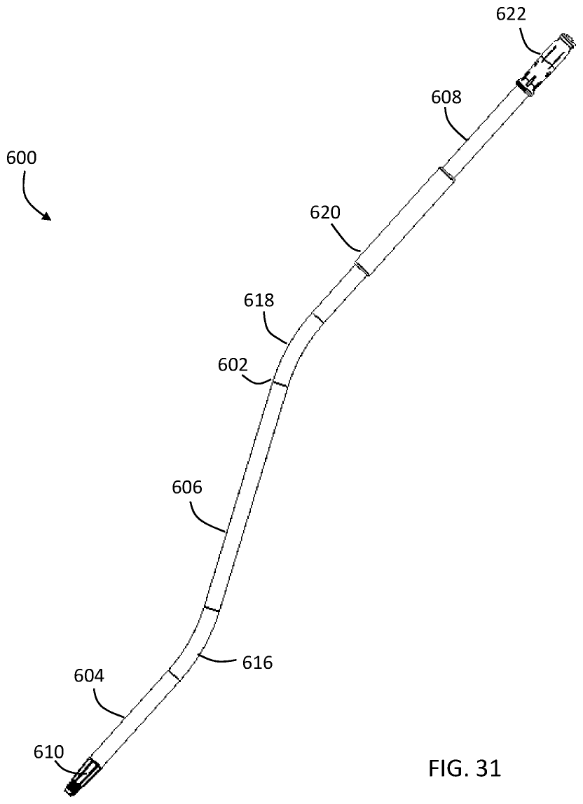

Referring now to FIGS. 30-36, a pole 600 in accordance with an embodiment of the present disclosure is shown for use with implements, such as cleaning implements. Similar to the pole 500, the pole 600 includes an elongated cylindrical member 602. In the illustrated embodiment, the member 602 is a thin walled tubular member made from a metallic material, such as but not limited to: aluminum, steel, metallic alloys, fiberglass, carbon fiber and epoxy, or wood or a combination of the foregoing with or without grips, texture or surface treatments for example. It should be appreciated that other materials, such as a plastic/polymer material or a combination or plastic and metal for example. It should further be appreciated that while embodiments herein may describe the member 602 as being tubular or hollow, this is for example reasons and the claims should not be so limited. In other embodiments, the member 602 may be made from a solid material. It is also contemplated that the cross section can be other than cylindrical, such as oval, trilobal, for example. The surface of the pole 600 can also be textured or have grips attached such as with adhesive.

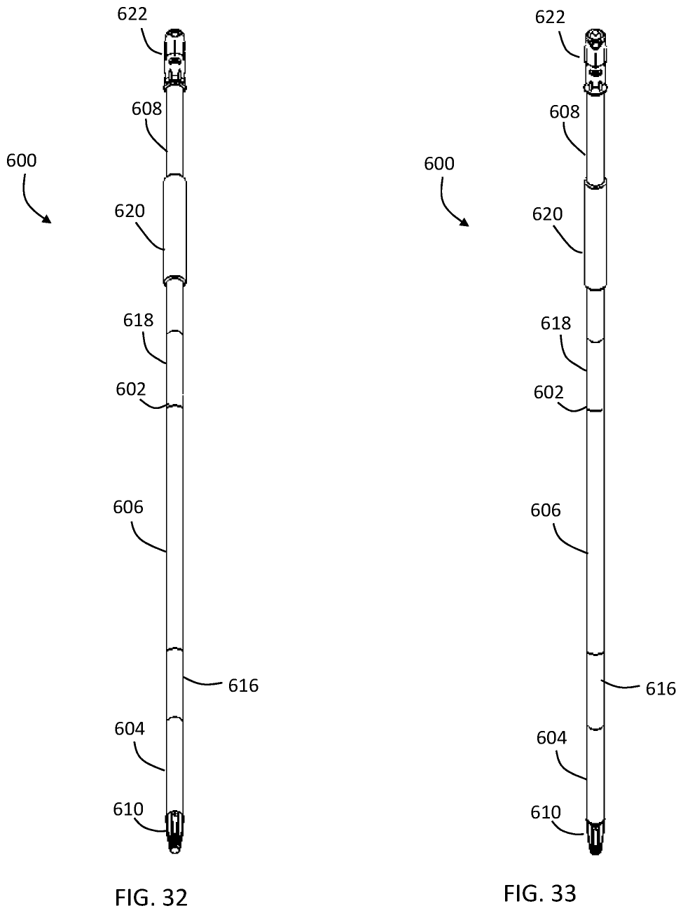

In this embodiment, the lengths and angles of the segments of member 602 provide for slightly higher height H and a shorter length L (FIG. 36) as will be discussed in more detail with respect to Table 1.

In the illustrated embodiment, the member 602 is comprised of a plurality of straight segments connected by curved segments. The straight segments are arranged to facilitate placing the implement at the desired orientation (angle relative to the surface it is placed) while allowing the user to push on the pole 600 and keep their back straight or substantial straight (e.g., not bent or hunched over) while making it easy (improving) to get the correct pushing (forward) and cleaning (downward) forces. The member 602 includes a first straight segment 604, a second straight segment 606, and a third straight segment 608.

Coupled to the first straight segment 604 is a coupler 610. In an embodiment, the coupler 610 is configured to engage a corresponding member on a cleaning implement or cleaning tool that is configured to secure the implement to the pole 600. In the illustrated embodiment, the coupler 610 has a threaded portion and a cone portion, however, any suitable coupling mechanism may be used. In the illustrated embodiment, the coupler 610 is substantially similar to the coupler 510, described above. In an embodiment, the coupler 610 is removably coupled to the member 602 to allow a coupler with a different attachment means to be used. In the illustrated embodiment, the coupler 610 includes a cylindrical portion sized to be received within the first straight segment 604. The coupler 610 may be secured to the first straight segment 604 by a fastener, detent pin, snap-fit, or the like (not shown). In an embodiment, the coupler 610 may be the same as that described in commonly owned United States Patent U.S. Pat. No. 7,413,366, the contents of which are incorporated by reference herein.

The second straight segment 606 is coupled to the first straight segment 604 by a first curved segment 616. In the illustrated embodiment the radius and center of the first curved segment 616 is sized and positioned such that the first straight segment 604 and the second straight segment 606 extend tangentially from the first curved segment 616. The second straight segment 606 is coupled to the third straight segment 608 by a second curved segment 618. In the illustrated embodiment the radius and center of the second curved segment 618 is selected such that the second straight segment 606 and the third straight segment 608 extend tangentially from the second curved segment 618.

Coupled to the third straight segment 608 is a grip member 620. In an embodiment, the grip member 620 is substantially similar to the grip member 620, shown and described above. The grip member 620 is made from a material that allows the user to comfortably hold the grip member 620 for periods of use. The grip member 620 may be made from a material such as foam, TPE, plastic or the like. In an embodiment, the grip member 620 may be movable along the length of the third straight segment 608 by the user. In an embodiment, the grip member 620 may be moved further down along the pole 600 onto the second curved member 618 or even the second straight segment 606, if desired by the user.

A handle 622 is coupled to an end of the third straight member 608. In the illustrated embodiment, the handle 622 is substantially similar to the handle 522 shown and described above. The handle 622 includes an opening on one end sized to receive the end of the third straight segment 608. The handle 622 may include a contoured outer surface that is shaped to allow the user to comfortably hold and apply force to the pole 600. The end of the handle 622 may be curved to allow a user to comfortably place their palm on the end if desired during use. In an embodiment, the handle 622 may include a hole that extends there through adjacent the end.

The proportions of the segments 604, 606, 608, 616, 618, 620, 622 of the pole 600 will be discussed herein with respect to Table 1. The sizes and proportions are selected to provide a desired height H and length L while maintaining the first segment 604 at the desired angle A₁ to place an implement 632 (FIG. 36) at the desired orientation to the work surface.

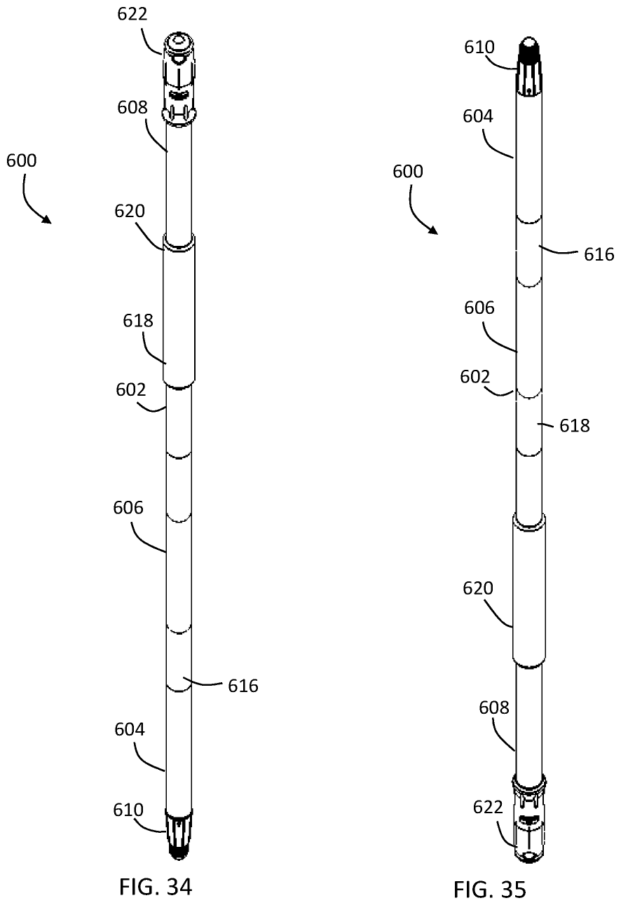

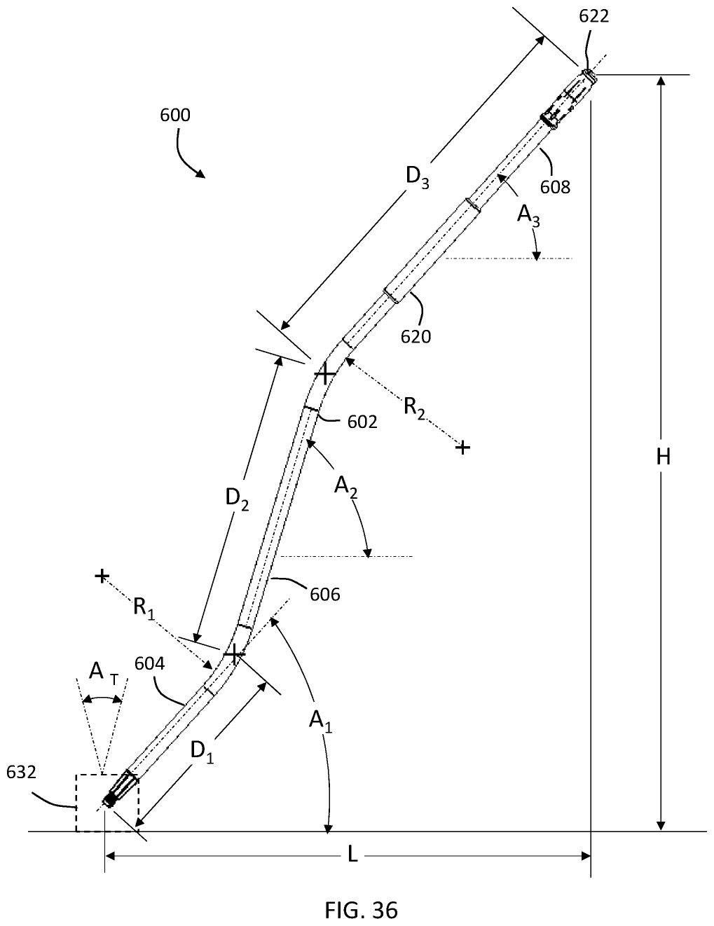

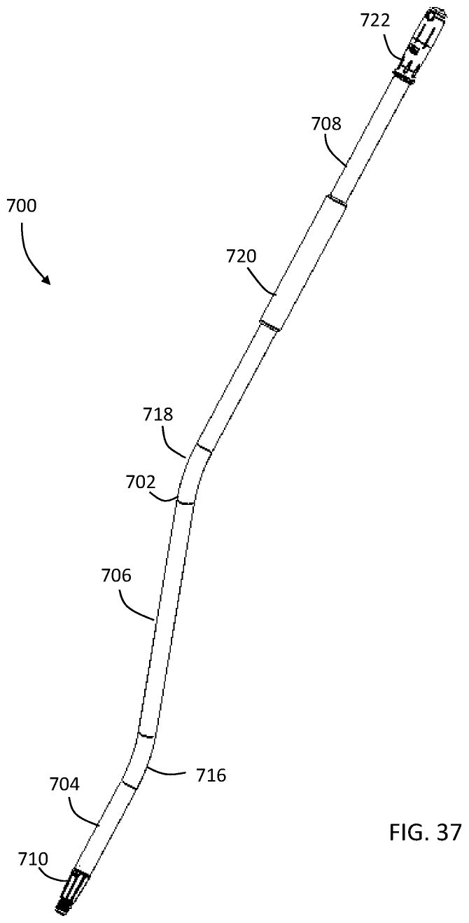

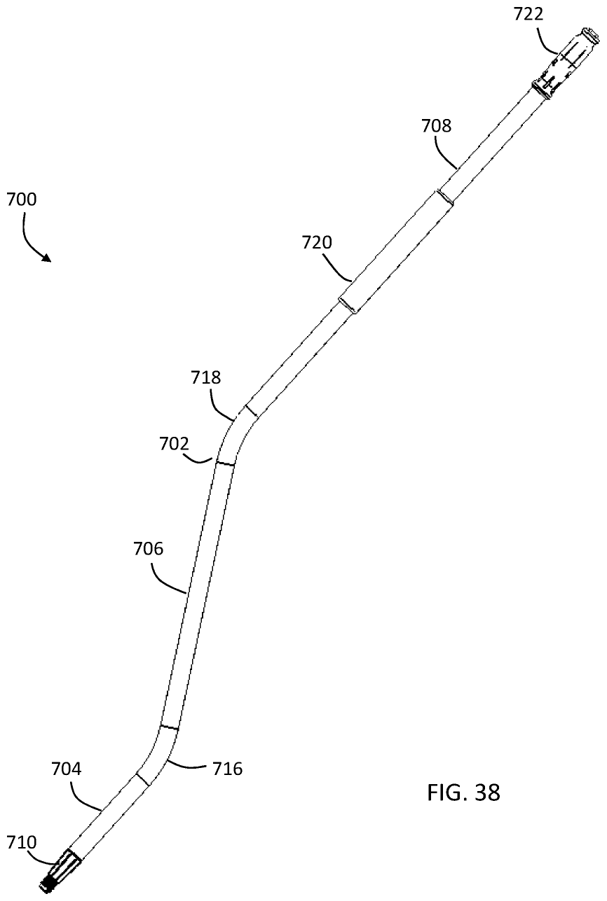

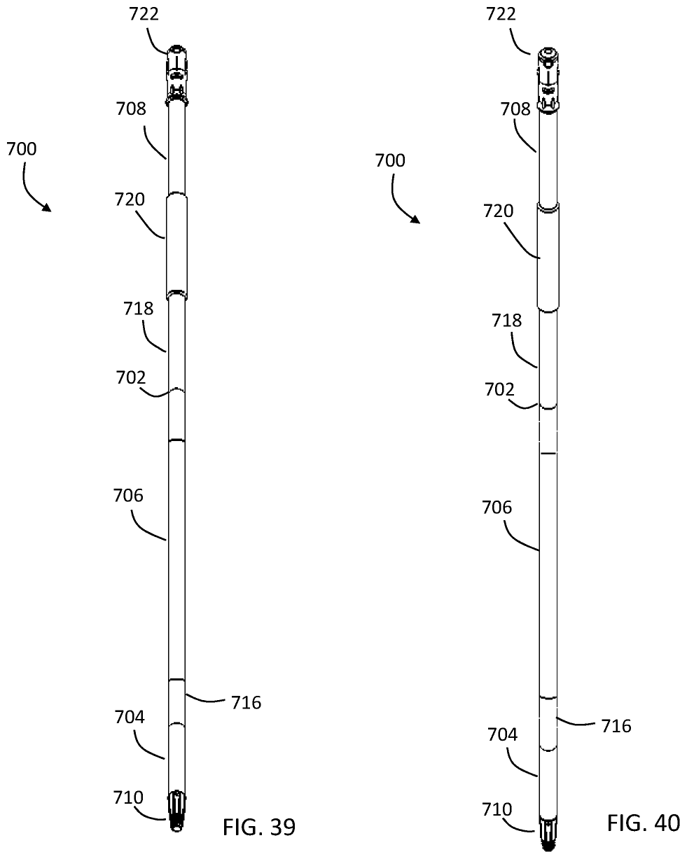

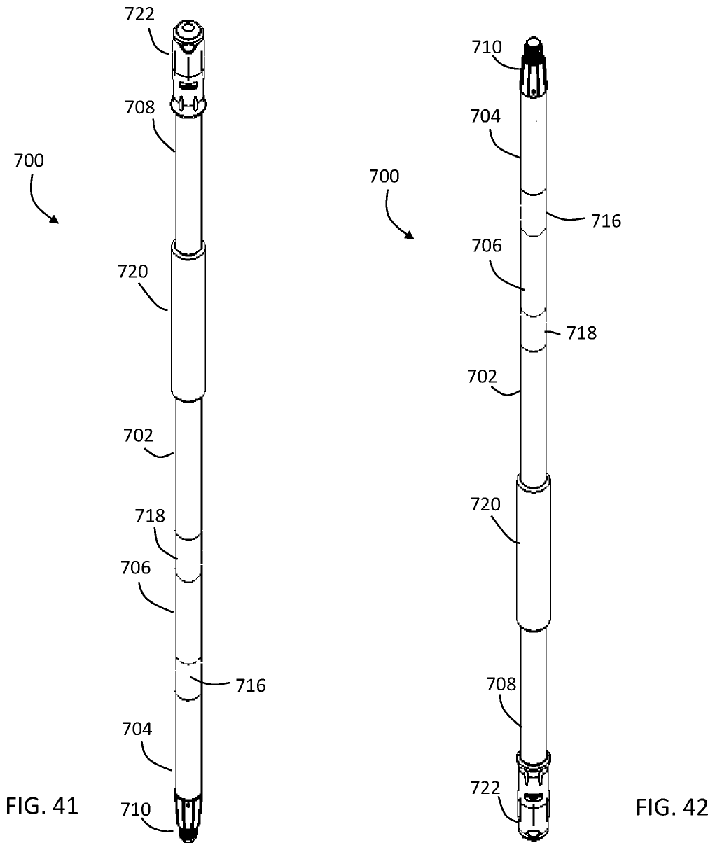

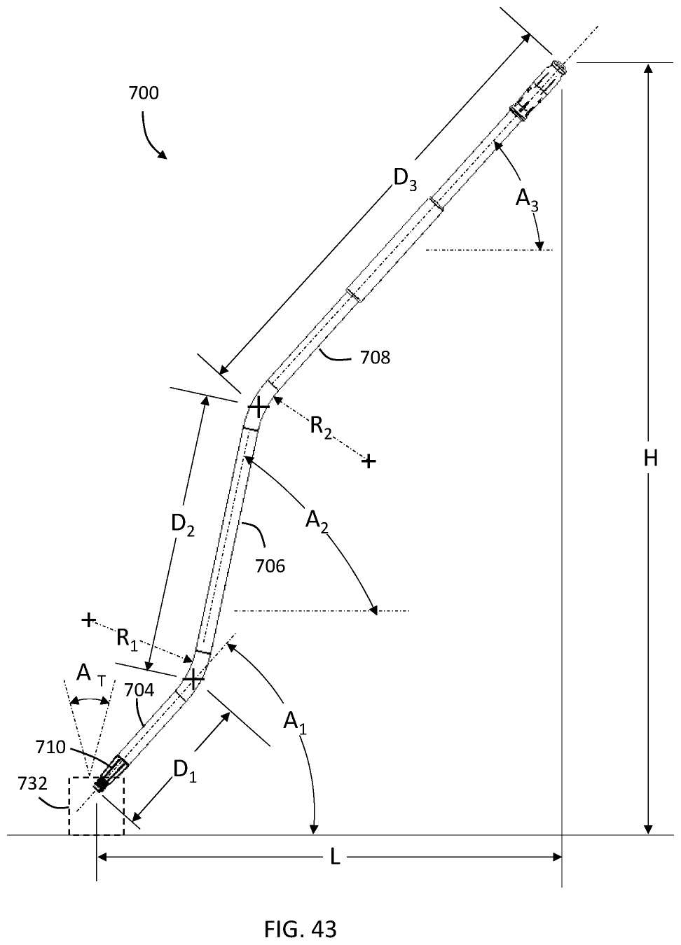

Referring now to FIGS. 37-43, another pole 700 in accordance with an embodiment of the present disclosure for use with implements, such as cleaning implements, is shown. Similar to the pole 500, the pole 700 includes an elongated cylindrical member 702. In the illustrated embodiment, the member 702 is a thin walled tubular member made from a metallic material, such as but not limited to: aluminum, steel, metallic alloys, fiberglass, carbon fiber and epoxy, or wood or a combination of the foregoing with or without grips, texture or surface treatments for example. It should be appreciated that other materials, such as a plastic/polymer material or a combination or plastic and metal for example. It should further be appreciated that while embodiments herein may describe the member 702 as being tubular or hollow, this is for example reasons and the claims should not be so limited. In other embodiments, the member 702 may be made from a solid material. It is also contemplated that the cross section can be other than cylindrical, such as oval, trilobal, for example. The pole surface can also be textured or have grips attached such as with adhesive. In this embodiment, the lengths and angles of the segments of member 702 provide for a higher height H and a shorter length L (FIG. 43) relative to the pole 500 as will be discussed in more detail with respect to Table 1.

In the illustrated embodiment, the member 702 is comprised of a plurality of straight segments connected by curved segments. The straight segments are arranged to facilitate placing the implement at the desired orientation (angle relative to the surface it is placed) while allowing the user to push on the pole 700 and keep their back straight or substantial straight (e.g., not bent or hunched over). The member 702 includes a first straight segment 704, a second straight segment 706, and a third straight segment 708. Coupled to the first straight segment 704 is a coupler 710. In an embodiment, the coupler 710 is configured to engage a corresponding member on a cleaning tool and secure the cleaning tool to the pole 700. In the illustrated embodiment, the coupler 710 has a threaded portion, however, any suitable coupling mechanism may be used. In the illustrated embodiment, the coupler 710 is substantially similar to the coupler 510. In an embodiment, the coupler 710 is removably coupled to the member 702 to allow a coupler with a different attachment means to be used. In the illustrated embodiment, the coupler 710 includes a cylindrical portion sized to be received within the first straight segment 704. The coupler 710 may be secured to the first straight segment 704 by a fastener, detent pin, snap-fit, or the like (not shown).

The second straight segment 706 is coupled to the first straight segment 704 by a first curved segment 716. In the illustrated embodiment the radius and center of the curved segment 716 is sized and positioned such that the first straight segment 704 and second straight segment 706 extend tangentially from the curved segment 716. The second straight segment 706 is coupled to the third straight segment 708 by a second curved segment 718. In the illustrated embodiment the radius and center of the second curved segment 718 is selected such that the second straight segment 706 and third straight segment 708 extend tangentially from the second curved segment 718.

Coupled to the third straight segment 708 is a grip member 720. In an embodiment, the grip member 720 is substantially similar to the grip member 520, shown and described above. The grip member 720 is made from a material that allows the user to comfortably hold the grip member for periods of use. In an embodiment, the grip member 720 may be movable along the length of the third straight segment 708 by the user. In an embodiment, the grip member 720 may be moved further down along the pole 700 onto the second curved member 718 or even the second straight segment 706, if desired by the user. A handle 722 is coupled to an end of the third straight member 708. In the illustrated embodiment, the handle 722 is substantially similar to the handle 522, shown and described above. The handle 722 includes an opening on one end sized to receive an end of the third straight segment 708. The handle 722 may include a contoured outer surface that is shaped to allow the user to comfortably hold and apply force to the pole 700. The end of the handle 722 may be curved to allow a user to comfortably place their palm on the end if desired during use. In an embodiment, the handle 722 may include a hole that extends there through adjacent the end.

The proportions of the segments 704, 706, 708, 716, 718, 720, 722 will be discussed herein with respect to Table 1. The sizes and proportions are selected to provide a desired height H and length L while maintaining the first segment 704 at a desired angle A₁ to place an implement 732 (FIG. 43) at a desired orientation to a work surface.

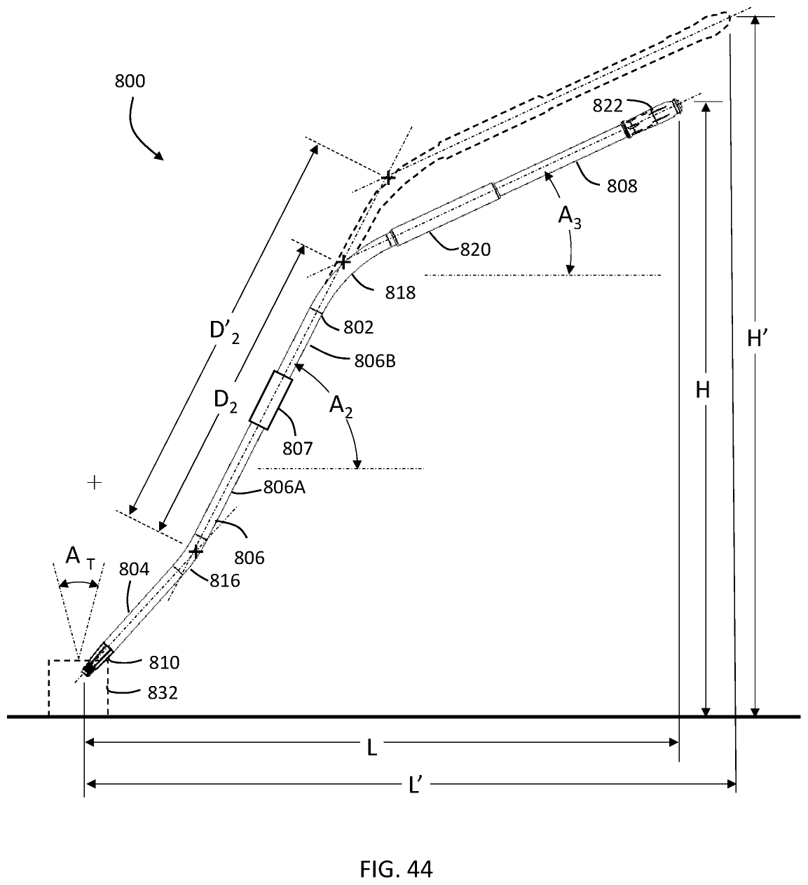

As discussed herein, it is desired to provide an ergonomic pole that allows the operator to use the implement, such as to clean a work surface, without having the user bend or hunch-over with their back. In order words, the ergonomic pole is arranged to keep the user's back straight, or substantially straight, during operation. This is accomplished while maintaining the first segment 504, 604, 704 at a desired angle for efficient operation of the implement 532, 632, 732 attached thereto. Referring again to FIG. 29, FIG. 36, FIG. 43, and FIG. 44, dimensions for examples of ergonomic poles 500, 600, 700, 800 is shown in accordance with one or more embodiments, where the angle A_{T} is the angle from vertical at which the cleaning tool 532, 632, 732, 832 may be efficiently operated, for example:

TABLE 1

| Type | A₁ (Deg) | A₃ (Deg) | A_{T} (Deg) | H (mm) |
|---|---|---|---|---|
| Pole 500 | 30-50 | 15-35 | +/−15 | 760-1270 |
| Pole 600 | 30-50 | 35-50 | +/−15 | 890-1400 |
| Pole 700 | 30-50 | 35-50 | +/−15 | 890-1400 |
| Pole 800 | 30-50 | 15-50 | +/−15 | 760-1270 |

The lengths of the straight segments D₁, D₂, D₃ are measured from the intersection of the centerlines (datum point) of the respective straight segments. The height H of the end of the handle is measured to the intersection of the centerline of the third straight segment and the end surface of the handle. The length of the pole is measured from the intersection of the centerline of the first straight segment and the bottom of the coupler to the intersection of the centerline of the third straight segment and the end surface of the handle. It has been found that that when the end of the pole 500, 600, 700, 800 is placed at the height H, length L, and angle A₁, the cleaning tool 532, 632, 732, 832 operates at the desired efficiency. It should be appreciated that the pole selected by the user may depend on the height of the user. A user who is taller may prefer pole 500 or pole 600, which have a higher operating height, while a user who is shorter may prefer pole 700 that has a lower operating height.

In one or more other embodiments, dimensions for the ergonomic poles 500, 600, 700, 800 may include, for example:

TABLE 2

| Type | A₁ (Deg) | A₃ (Deg) | A_{T} (Deg) | H (mm) |
|---|---|---|---|---|
| Pole 500 | 10-80 | 0-60 | +/−30 | 505-1270 |
| Pole 600 | 10-80 | 0-60 | +/−30 | 635-1400 |
| Pole 700 | 10-80 | 0-60 | +/−30 | 635-1400 |
| Pole 800 | 10-80 | 0-60 | +/−30 | 505-1270 |

In still further embodiments, dimensions for the ergonomic poles 500, 600, 700 may include, for example:

TABLE 3

| Type | A₁ | A₂ | A₃ | A_{T} | H | D1 | D2 | D3 | R1 | R2 | L |
|---|---|---|---|---|---|---|---|---|---|---|---|
| Pole 500 | 40-50 | 55-65 | 17-27 | +/−15 | 1025-1100 | 150-240 | 480-640 | 600-710 | 165-300 | 165-300 | 1060-1100 |
| Pole 600 | 40-50 | 70-75 | 40-50 | +/−15 | 1200-1275 | 200-270 | 525-550 | 670-700 | 165-300 | 165-300 | 790-820 |
| Pole 700 | 40-50 | 70-85 | 40-50 | +/−15 | 1200-1275 | 150-275 | 480-560 | 700-790 | 165-300 | 165-300 | 750-770 |

Referring now to FIG. 44, an embodiment is shown of a pole 800 that includes an adjustable straight segment that allows the pole 800 to be changed to accommodate users of different heights. The pole 800 includes an elongated cylindrical member 802. The member 802 is comprised of a first straight segment 804, an adjustable second straight segment 806, and a third straight segment 808. Similar to the poles shown and described above, the first straight segment 804 is connected to the adjustable second straight segment 806 by a first curved segment 816. The adjustable second straight segment 806 is connected to the third straight segment 808 by a second curved segment 818. A coupler 810 is coupled to the end of the first straight segment 804. A grip member 820 and a handle 822 are coupled to the third straight segment 808. In an embodiment, the coupler 810, the grip member 820, and the handle 822 may be substantially similar to the similar components shown and described above, respectively.

In this embodiment, the second segment 806 is adjustable between a first position (shown in solid line in FIG. 44) having a length D₂ to a second position (shown in dashed line in FIG. 44) with a length D₂′. It should be appreciated that while when the length of the second segment 806 is changed, the height of the end of the handle will increase from a first height H to a second height H′. Similarly, the length of the pole 800 will change from a first length L to a second length L′.

In an embodiment, the second segment 806 includes two portions 806A, 806B that are coupled by one or more collars 807 or clamps. The collar 807 may be tightened or loosened to allow one of the two portions 806A, 806B to slide relative to the other of the two portions 806A, 806B to change the length of the second segment 806 or a clamp can be used. It should be appreciated that the two portions 806A, 806B may have different diameters. When at the desired length, the collar 807 may be tightened to fix the second segment 806 at the desired length. In an embodiment, the length of the second straight segment 806 is adjustable based on the number of collars that are used, such as shown in Table 4:

TABLE 4

| Embodiment | Adjustment Range | First Length | Second Length |
|---|---|---|---|
| One collar | 350 mm | 450 mm | 800 mm |
| Two collars | 550 mm | 450 mm | 1000 mm |

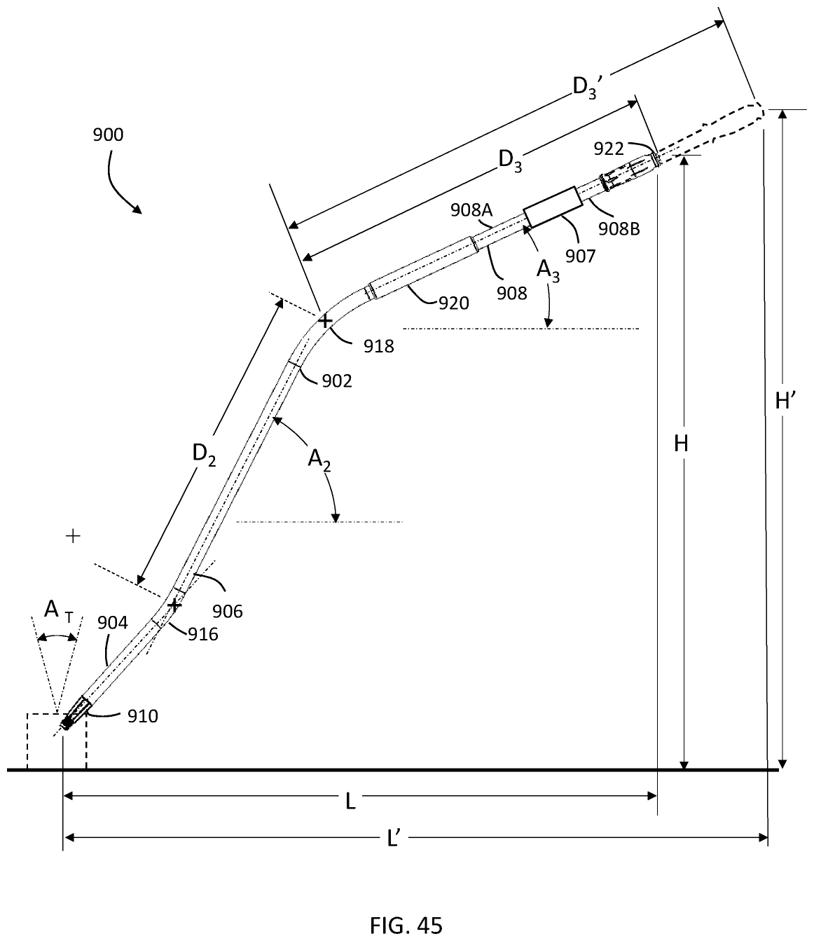

Referring now to FIG. 45, a pole 900 in accordance with an embodiment of the present disclosure that includes an adjustable straight segment that allows the pole 900 to be changed to accommodate users of different heights and/or a different length. The pole 900 includes an elongated cylindrical member 902. The member 902 is comprised of a first straight segment 904, a second straight segment 906 and an adjustable third straight segment 908. Similar to the other poles shown and described above, the first straight segment 904 is connected to the adjustable second straight segment 906 by a first curved segment 916. The second straight segment 906 is connected to the adjustable third straight segment 908 by a second curved segment 918. A coupler 910 is coupled to the end of the first straight segment 904. A grip member 920 and a handle 922 are coupled to the adjustable third straight segment 908. In an embodiment, the coupler 910, the grip member 920 and the handle 922 may be substantially similar to the similar components shown and described above, respectively.

In this embodiment, the third segment 908 is adjustable between a first position (shown in solid line in FIG. 45) having a length D₃ to a second position (shown in dashed line in FIG. 45) with a length D₃′. It should be appreciated that while when the length of the third segment 908 is changed, the height of the end of the handle will increase from a height H to a second height H′. Similarly, the length of the pole 900 will change from the initial length L to a second length L′.

In an embodiment, the third segment 908 includes two portions 908A, 908B that are coupled by a collar 907 or a clamp. The collar 907 may be tightened or loosened to allow one of the two portions 908A, 908B to slide into the other of the two portions 908A, 908B to change the length of the third segment 908. It should be appreciated that the two portions 908A, 908B may have different diameters. When at the desired length, the collar 907 is tightened to fix the second segment 908 at that length. In an embodiment, the length of the third straight segment is adjustable depending on the number of collars used as shown in Table 5:

TABLE 5

| Embodiment | Adjustment Range | First Length | Second Length |
|---|---|---|---|
| One collar | 500 mm | 600 mm | 1100 mm |
| Two collars | 775 mm | 425 mm | 1200 mm |

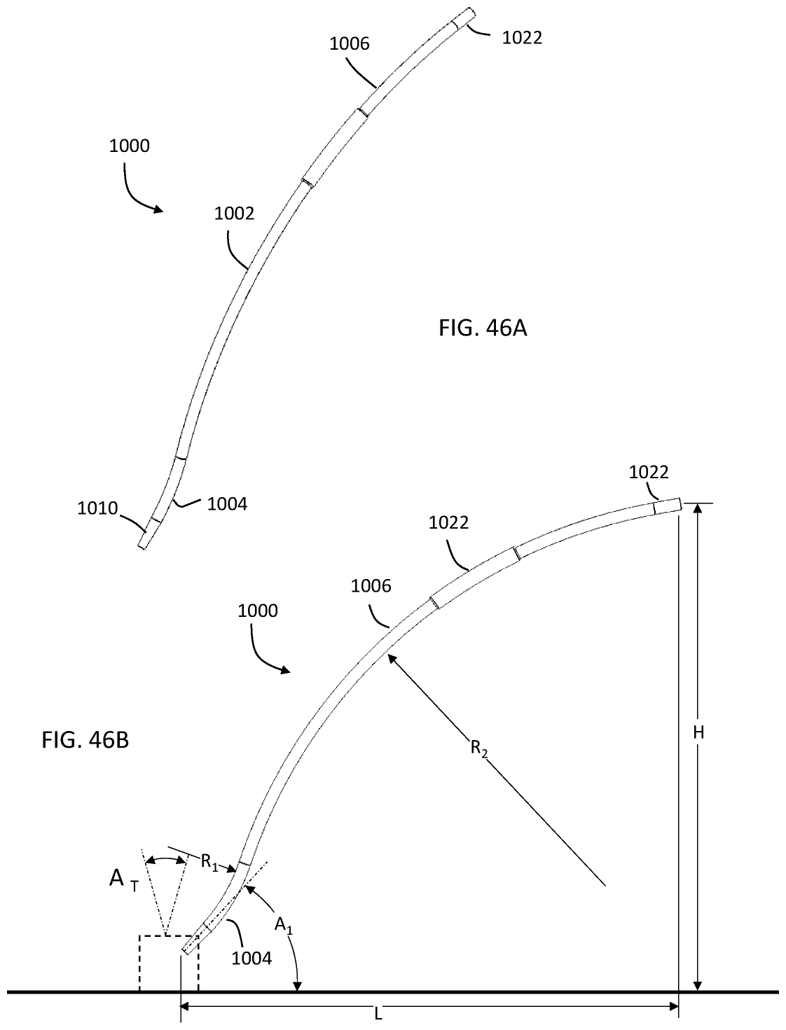

Referring now to FIGS. 46A-46B, another embodiment is shown of a pole 1000 in accordance with an embodiment of the present disclosure. The pole 1000 includes an elongated cylindrical member 1002 having a coupler 1010 at a first end and a handle 1022 at an opposite end. In an embodiment, the coupler 1010 and the handle 1022 may be substantially similar to the components shown and described above. In this embodiment, the member 1002 includes a first curved segment 1004 and a second segment 1006. The segments 1004, 1006 are sized to place the handle 1022 at a height H of about 25-50 inches above the surface while maintaining a cleaning implement or tool at the desired orientation/angle A_{T} relative to the surface. In the illustrated embodiment, the angle A₁ may be between 10-80 degrees, between 30-50 degrees, or between 40-50 degrees. In this illustrative embodiment, the first segment 1004 has a curved radius R₁ and the second segment 1006 has a curved radius R₂. In the illustrated embodiment, the radius R₁ is about 200-600 mm and the radius R₂ is about 1000-1400 mm.

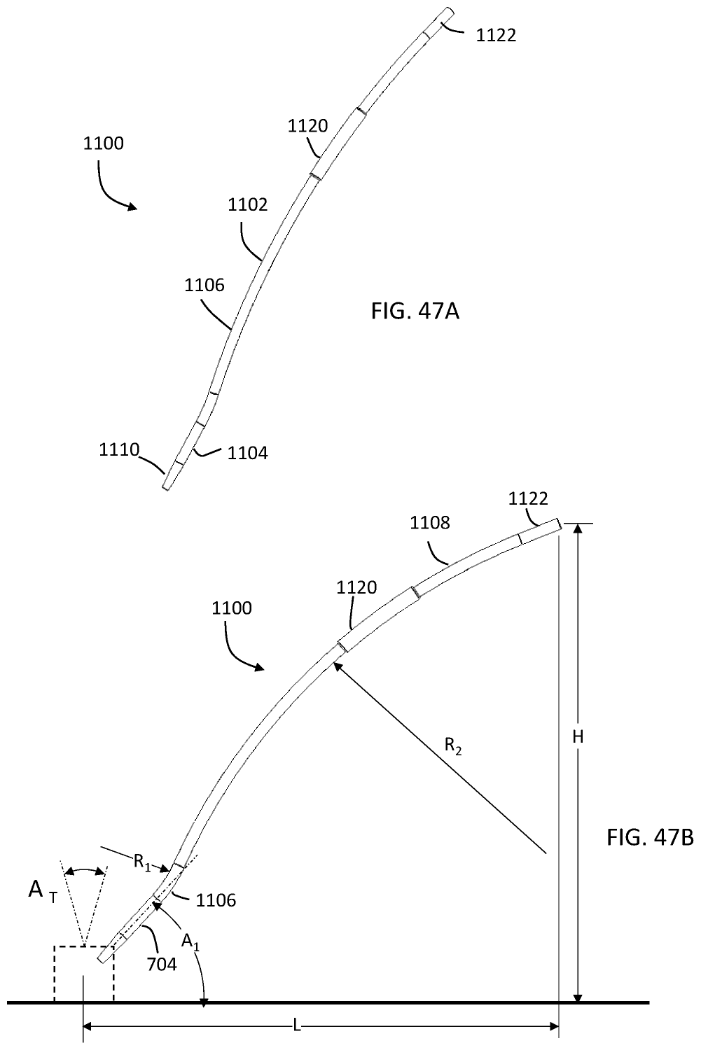

Referring now to FIGS. 47A-47B, another embodiment of a pole 1100 in accordance with an embodiment of the present disclosure is shown. The pole 1100 includes an elongated cylindrical member 1102 having a coupler 1110 at a first end and a handle 1122 at an opposite end. In an embodiment, the coupler 1110 and handle 1122 are substantially similar to the components shown and described above. In this embodiment, the member 1102 includes a first straight segment 1104, a second curved segment 1106, and a third curved segment 1108. The segments 1104, 1106, 1106 are sized to place the handle 1122 at a height H of about 25-50 inches about the surface while maintaining the implement at the desired orientation/angle A_{T}. In the illustrated embodiment, an angle A₁ may be between 10-80 degrees, between 30-50 degrees, or between 40-50 degrees. In this embodiment, the second segment 1106 has a curved radius R₁ and the third segment 1108 has a curved radius R₂. In the illustrated embodiment, the radius R₁ is about 200-400 mm and the radius R₂ is about 1300-1700. A grip member 1120 is disposed on and coupled to the second segment 1108.

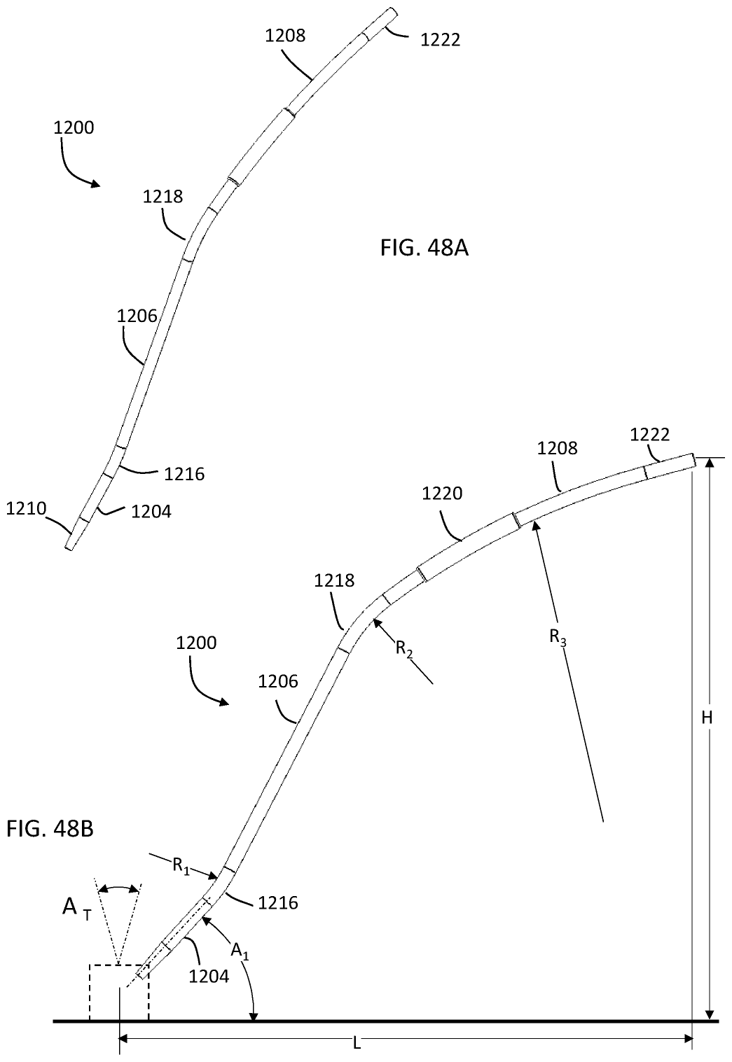

Referring now to FIGS. 48A-48B, a pole 1200 in accordance with an embodiment of the present disclosure is shown. The pole 1200 includes an elongated cylindrical member 1220 having a coupler 1210 at a first end and a handle 1222 at an opposite end. In an embodiment, the coupler 1210 and the handle 1222 are substantially similar to the components shown and described above. In this embodiment, the member 1202 includes a first straight segment 1204, a second straight segment 1206, and a third curved segment 1208. The segments 1204, 1206, 1208 are sized to place the handle 1222 at a height H of about 25-50 inches about the surface while maintaining the implement at the desired orientation/angle A_{T}. In the illustrated embodiment, an angle A₁ may be between 10-80 degrees, between 30-50 degrees, or between 40-50 degrees. The first segment 1204 is connected to the second segment 1206 by a curved segment 1216 having a radius R₁. In an embodiment, the radius R₁ is about 1200-1400 mm. The second segment 1206 is connected to the third segment 1208 with a curved segment 1218 having a radius R₂. In an embodiment, the radius R₂ is about 200-400 mm. In this embodiment, the third segment 1208 has a curved radius R₃. In the illustrated embodiment, the radius R₃ is about 1300-1700.

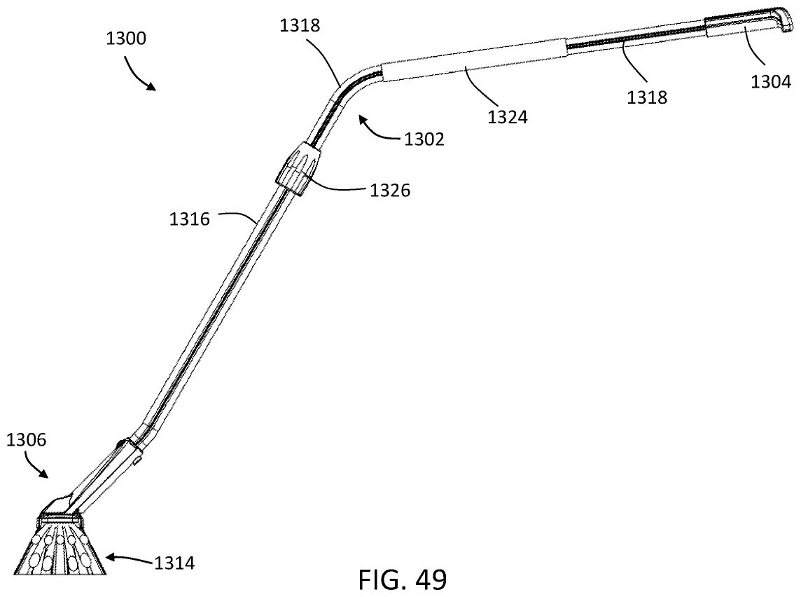

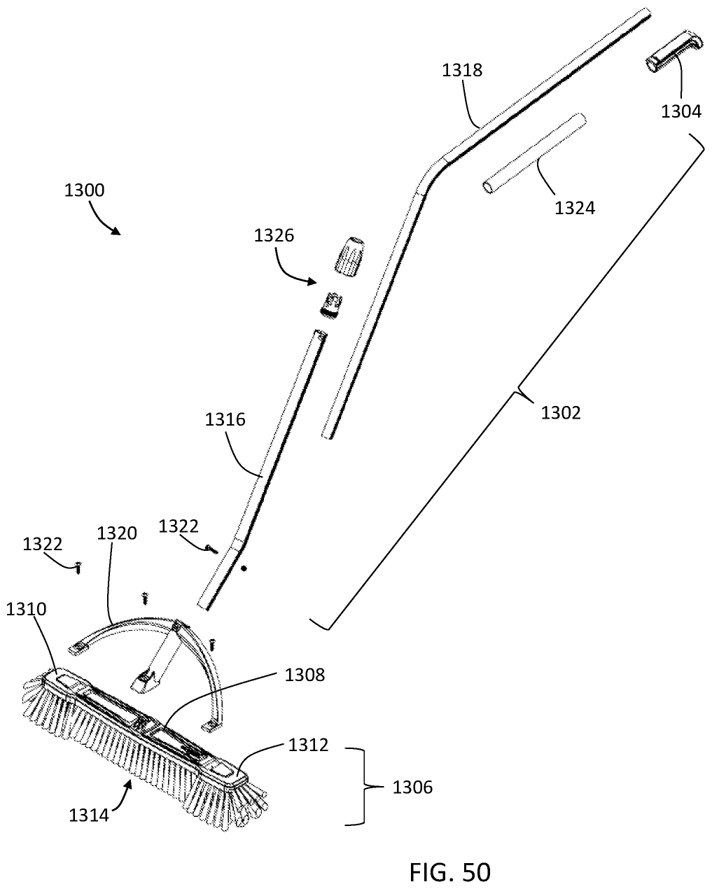

Referring now to FIG. 49-FIG. 50, a cleaning tool 1300 (e.g., a broom) in accordance with an embodiment of the present disclosure is shown. The cleaning tool 1300 includes a pole 1302 (e.g., fixed pole or extendable pole) having a handle 1304 on one end. Coupled to the pole 1302, on an end opposite from the handle 1304, is a head member assembly 1306. The head member assembly 1306 includes a center head member 1308 and a pair of separately couplable end modules 1310, 1312. The center head member 1308 and the end modules 1310, 1312 each have cleaning elements 1314 (e.g., bristles). As described in more detail herein, and in some embodiments, the cleaning elements 1314 may be formed from a plurality of bristle types, such a two-type, three-type, four-type, or more bristle types that are of different stiffness, diameter, bristle shape, flagged or unflagged, straight or crimped, material or a combination of the foregoing. It should be appreciated that in some embodiments, the cleaning elements 1314 on the center head member 1308 and the end modules 1310, 1312 may be the same, may be different, or may include combinations of similar and different type of cleaning elements.

The pole 1302 may be a thin walled tubular member made from a material, such as but not limited to: aluminum, steel, metallic alloys, fiberglass, carbon fiber and epoxy, or wood or a combination of the foregoing with or without grips, texture, or surface treatments. It should be appreciated that other materials, such as a plastic/polymer material or a combination of plastic and metal for example. The pole 1302 may be tubular or hollow but may alternatively be a solid. It is also contemplated that the cross section of the pole 1302 can be other than cylindrical, such as oval, trilobal, squared, etc. The exterior surface of the pole 1302 can also be textured and/or have grips attached, such as with adhesive and/or fastener.

In this illustrated embodiment, the pole 1302 is comprised of bent segments that may be connected or otherwise attached together to form the pole 1302. The bent segments are arranged to facilitate placing the head member assembly 1306 at a desired orientation (e.g., an angle relative to a surface to be cleaned) while allowing a user to push on the pole 1302 and keep their back straight or substantially straight (e.g., not bent or hunched over) while making it easy (improving) to get the correct pushing (forward) and cleaning (downward) forces.

In this illustrative embodiment, the pole 1302 includes a first bent segment 1316 and a second bent segment 1318. The first bent segment 1316 is configured to engage with and secure the pole 1302 to the head member assembly 1306 by a bracket 1320. The bracket 1320 is configured to provide a secure connection between the pole 1302, the center head member 1308, and the end modules 1310, 1312, by (as shown) a plurality of fasteners 1322 (e.g., screws, nuts and bolts, detent pins, snap-fit connections, or the like). In some configurations, the bent segments 1316, 1318 may be single, unitary bodies formed from a single bent, formed, or shaped tube or the like, or may be formed from multiple different straight and curved segments, similar to that shown and described above.

As shown, the second bent segment 1318 can include the handle 1304 and a grip member 1324. The grip member 1324 may be made from a material that allows a user to comfortably hold the grip member 1324 for periods of use. The grip member 1324 may be made from a material such as foam, thermoplastic elastomer (TPE), plastic, or the like. The grip member 1324 could be smooth or have finger grips or may have a contoured outer surface that is shaped to allow a user to comfortably hold and apply force to the pole 1302. The grip member 1324 may be movable along the length of the second bent segment 1318 by a user. The handle 1304 includes an opening on one end sized to receive an end of the second bent segment 1318. The handle 1304 can include a contoured outer surface that is shaped to allow a user to comfortably hold and apply force to the pole 1302. An end of the handle 1304 may be curved to allow a user to comfortably place their palm on the end, if desired during use.

As shown, the cleaning tool 1300 is adjustable along the pole 1302 by means of an adjustment member 1326. The adjustment member 1326 is configured to selectively couple the first bent member 1316 to the second bent member 1318 to enable adjustment of a length of the pole 1302. The adjustment of the length may enable changing of height of the pole 1302, as described above. The adjustment member 1326 may also allow for relatively rotational adjustment between the first bent pole 1316 and the second bent pole 1318.

As noted, in this embodiment, the bent segments 1316, 1318 form the pole 1302. The bent segments 1316, 1318 may be pre-formed with desired angles to encourage a user to clean using the cleaning tool 1300 at an optimal angle. However, because users may be of different heights, the cleaning tool 1300 is adjustable, using the adjustment member 1326. In an embodiment, the pole 1302 is sized and shaped in the same manner as described herein with respect to FIG. 44 or FIG. 45.

It will be appreciated that the head member assemblies described herein (e.g., shown and described with respect to FIGS. 1-21B) may be attached to the poles described herein (e.g., shown and described with respect to FIGS. 22-51). As such, different modular cleaning tool heads may be used with ergonomic and/or adjustable poles/handles to enable customized cleaning tools to be assembled and used for desired purposes and/or by users having different heights.

It should be noted that the terms “first,” “second,” “upper,” “top,” “bottom,” “lower,” “front,” and “rear,” and the like may be used herein to modify various elements. These modifiers do not imply a spatial, sequential, or hierarchical order to modify the elements unless specifically stated. The term “about” is intended to include the degree of error associated with measurement of the particular quantity based upon the equipment available at the time of filing the application.

The terminology used herein is for the purpose of describing particular embodiments only and is not intended to be limiting of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the disclosure is provided in detail in connection with only a limited number of embodiments, it should be readily understood that the disclosure is not limited to such disclosed embodiments. Rather, the disclosure can be modified to incorporate any number of variations, alterations, substitutions or equivalent arrangements not heretofore described, but which are commensurate with the spirit and scope of the disclosure. Additionally, while various embodiments of the disclosure have been described, it is to be understood that the exemplary embodiment(s) may include only some of the described exemplary aspects. Accordingly, the disclosure is not to be seen as limited by the foregoing description, but is only limited by the scope of the appended claims.

What is claimed is:

1. A tool for cleaning a surface comprising:
a pole having a first end and a second end, the pole comprising:
a first bent segment and a second bent segment; and
a head member assembly coupled to the first end of the pole, the head member assembly comprising:
a center head member configured to be coupled to the first end of the pole, the center head member having at least one tongue member extending from an end of the center head member;
a first plurality of bristles extending from a surface of the center head member opposite the pole;
an end module removably coupled to the tongue member of the center head member; and
a second plurality of bristles extending from a surface of the end module and positioned adjacent the first plurality of bristles, the second plurality of bristles including a first portion of bristles that extend at a first angle relative to an end surface of the end module in a direction away from the pole.

2. The tool of claim 1, wherein a portion of the first bent segment is disposed on an angle of about 25 degrees to 40 degrees relative to a surface being cleaned when the head member assembly is in an operating position.

3. The tool of claim 1, wherein the second end is positioned about 630-1400 mm from the surface when the head member assembly is in the operating position.

4. The tool of claim 1, wherein the first angle is greater than or equal to 0 and less than or equal to 90 degrees.

5. The tool of claim 1, wherein the first plurality of bristles includes a plurality of periphery bristles and a plurality of center bristles, the plurality of center bristles being different than periphery bristles.

6. The tool of claim 1, wherein the second plurality of bristles includes a second portion of bristles, the second portion of bristles being different than the first portion of bristles, the periphery bristles and the plurality of center bristles.

7. The tool of claim 1, wherein the first plurality of bristles have a different material, diameter, bristle shape, straight or crimped, flagged or unflagged, or stiffness than the second plurality of bristles.

8. The tool of claim 1, wherein a portion of the first bent segment is disposed on an angle of about 30 to 60 degrees when the floor cleaning implement is in the operating position.

9. The tool of claim 1, wherein the second bent segment comprises at least one straight segment and a curved segment, wherein at least one of the straight segments of the second bent segment is configured to change length.

10. The tool of claim 1, wherein the first bent segment comprises a first curved segment and a first straight segment and the second bent segment comprises a second curved segment and a second straight segment.

11. The tool of claim 1, wherein the pole includes at least one of (i) a first curved portion along the first bent segment and (ii) a second curved portion along the second bent segment.

12. The tool of claim 1, wherein the first bent segment comprises a first segment having a first axis and a second segment having a second axis, and the second bent segment comprises a third segment having a third axis, wherein a first intersection of the first axis and the second axis define a first datum point and a second intersection of the second axis and the third axis defining a second datum point.

13. The tool of claim 12, wherein the third segment has a length of about 670-790 mm from the second datum point to the second end.

14. The tool of claim 12, wherein the first segment has a length of about 150-270 mm from the first end to the first datum point.

15. The tool of claim 1, further comprising an additional end module removably coupled to a tongue member of the center head member opposite the end module.

16. A tool for cleaning a surface comprising:
an ergonomic pole comprising:
a pole having a first end and a second end, the pole further having a first segment adjacent the first end, a third segment adjacent the second end and a second segment disposed between the first segment and the third segment; and
a cleaning implement coupled to the first end,
wherein the first segment is disposed on a functional angle of about 30 degrees to 60 degrees relative to a surface being cleaned when the floor cleaning implement is in an operating position, and
wherein at least one of the second segment and the third segment is adjustable from a respective first length to a respective second length,
wherein the cleaning implement comprises:
a center head member configured to be coupled to the first end of the pole, the center head member having a first tongue member extending from a first end of the center head member and a second tongue member extending from a second end of the center head member opposite the first tongue member;
a first end module removably coupled to the first tongue member; and
a second end module removably coupled to the second tongue member,
wherein each of the center head member, the first end module, and the second end module include a respective plurality of cleaning element extending therefrom.

17. The tool of claim 16, wherein the cleaning elements of the center head member, the first end module, and the second end module are bristles.

18. The tool of claim 17, wherein the bristles of the center head member, the first end module, and the second end module include one or more groups of bristles having different characteristics selected from a group consisting of bristle diameter, bristle shape, flagged/unflagged bristles, straight/crimped bristles, stiffness, and material.

19. The tool of claim 17, wherein the bristles have a bristle shape selected from a group consisting of round, triangular, quadrilobal, and rectangular.

20. The tool of claim 17, wherein the bristles have a bristle material selected from a group consisting of polymer, natural fiber, metal, composite, polyester, polypropylene, nylon, thermoplastic elastomer (TPE), polytetrafluoroethylene, boar hair, horse hair, Tampico fiber, Palmetto fiber, brass, steel, and carbon fiber.

21. The tool of claim 16, further comprising a third end module configured to be removably coupled to at least one of the first tongue member or the second tongue member, the third extension member having a respective cleaning element extending therefrom.

22. The tool of claim 21, wherein the third end module has a length that is longer than the first end module and the second end module.

23. The tool of claim 16, wherein the first segment and the second segment define a first bent segment and the third segment defines a second bent segment.
